(19) United States
(12) Patent Application Publication
(10) Pub. No.: US 2022/0386224 A1
(43) Pub. Date: Dec. 1, 2022

(54) USER EQUIPMENT (UE) AND COMMUNICATION CONTROL METHOD

(71) Applicant: SHARP KABUSHIKI KAISHA, Sakai City, Osaka (JP)

(72) Inventor: YUDAI KAWASAKI, Sakai City, Osaka (JP)

(21) Appl. No.: 17/772,430

(22) PCT Filed: Oct. 30, 2020
(86) PCT No.: PCT/JP2020/040883

§ 371 Date: Apr. 27, 2022

(30) Foreign Application Priority Data
Nov. 1, 2019 (JP) 2019-199745

(51) Int. Cl. H04W 48/16

(52) U.S. Cl. CPC H04W 48/16

(57) ABSTRACT

A communicator is provided that, in a 5GS, in a case that a User Equipment (UE) is registered with a Non-Public Network (NPN) and a Local Area Data Network (LADN) is connectable, allows the UE to appropriately process information of the LADN received from a control apparatus of a core network. Furthermore, the communicator also allows the control apparatus of the core network to perform appropriate error processing in a case that a UE is registered with a Non-Public Network (NPN) and a Local Area Data Network (LADN) is not connectable. Thus, provided is the communicator that, in 5GS, in a case that the UE is registered with the Non-Public Network (NPN) and the Local Area Data Network (LADN) is connectable, implements processing of the control apparatus of the core network and processing of the UE.

### TECHNICAL FIELD

The present application relates to a User Equipment (UE) and a communication control method. This application claims the benefit of priority to JP 2019-199745 filed on Nov. 1, 2019, which is incorporated herein by reference in its entirety.

### BACKGROUND ART

In the 3rd Generation Partnership Project (3GPP), studies on system architecture of a 5G System (5GS) being a mobile communication system of the next generation, that is, the fifth generation (5G), have been initiated, and support of new procedures and new functions has been discussed (see NPL 1, NPL 2, and NPL 3).

For example, requirement conditions include optimization and diversification of communication procedures for supporting continual mobile communication services according to various services, optimization of system architecture in accordance with the optimization and the diversification of the communication procedures, and the like.

### CITATION LIST

### Non Patent Literature

NPL 1: 3GPP TS 23.501 V16.2.0 (2019-09); Technical Specification Group Services and System Aspects; System Architecture for the 5G System; Stage 2 (Release 16)

NPL 2: 3GPP TS 23.502 V16.2.0 (2019-09); Technical Specification Group Services and System Aspects; Procedures for the 5G System; Stage 2 (Release 16)

NPL 3: 3GPP TS 24.501 V16.2.0 (2019-09); Technical Specification Group Core Network and Terminals; Non-Access-Stratum (NAS) protocol for 5G System (5GS); Stage 3 (Release 16)

### SUMMARY OF INVENTION

### Technical Problem

For the 5G System (5GS), a 5G Core Network (5GCN) corresponding to a new core network has been under study in order to provide a wide variety of services. Note that the 5GS supports new functions such as a function to provide connectivity to LADN (trade name) (Local Area Data Network).

Furthermore, for the 5GS, studies have been conducted about provision of a non-public network that can be used by a specific user for a specific purpose, such as a Non-Public Network (NPN), and a function to realize a non-public network.

However, processing of a control apparatus for a core network and processing of a user equipment (UE) are not clarified, the processing being performed in a case that the user equipment is registered with the NPN.

In view of the above-described circumstances, an object of the present invention is to provide a method for realizing, in a 5GS, processing of a control apparatus for a core network and processing of a user equipment, the processing being performed in a case that the user equipment is registered with an NPN and can be connected to an LADN.

### Solution to Problem

A User Equipment (UE) according to an embodiment of the present invention includes: a transmission and/or reception circuitry configured to receive, from a control apparatus, a REGISTRATION ACCEPT message including Local Area Data Network (LADN) information; and a controller configured to store the LADN information based on reception of the REGISTRATION ACCEPT message, wherein the LADN information includes LADN service area information, and in a case that the UE is operating in a Standard-alone-Non-Public Network (SNPN) access mode, the controller considers the LADN information to be valid in a Tracking Area Identity (TAI) of a registered SNPN, and the TAI of the registered SNPN is included in the LADN service area information.

A communication control method for a User Equipment (UE) according to an embodiment of the present invention includes the steps of: receiving, from a control apparatus, a REGISTRATION ACCEPT message including Local Area Data Network (LADN) information; and storing the LADN information based on reception of the REGISTRATION ACCEPT message, wherein the LADN information includes LADN service area information, and in a case that the UE is operating in a Standard-alone-Non-Public Network (SNPN) access mode, the UE considers the LADN information to be valid in a Tracking Area identity of a registered SNPN, and the TAI of the registered SNPN is included in the LADN service area information.

### Advantageous Effects of Invention

According to an aspect of the present invention, in the 5GS, error processing of a control apparatus for a core network and error processing of a user equipment can be realized, the processing being performed in a case that information for connectivity to the LADN requested by the user equipment is not valid.

### BRIEF DESCRIPTION OF DRAWINGS

FIG. 1 is a diagram illustrating an overview of a mobile communication system (EPS/5GS).

FIG. 2 is a diagram illustrating a detailed configuration of the mobile communication system (EPS/5GS).

FIG. 3 is a diagram illustrating an apparatus configuration of a UE.

FIG. 4 is a diagram illustrating a configuration of an access network apparatus (gNB) in the 5GS.

FIG. 5 is a diagram illustrating a configuration of a core network apparatus (AMT/SMF/UPF) in the 5GS.

FIG. 6 is a diagram illustrating a registration procedure.

FIG. 7 is a diagram illustrating a PDU session establishment procedure.

### DESCRIPTION OF EMBODIMENTS

With reference to the drawings, the best embodiments for carrying out the present invention will be described.

### 1. Overview of System

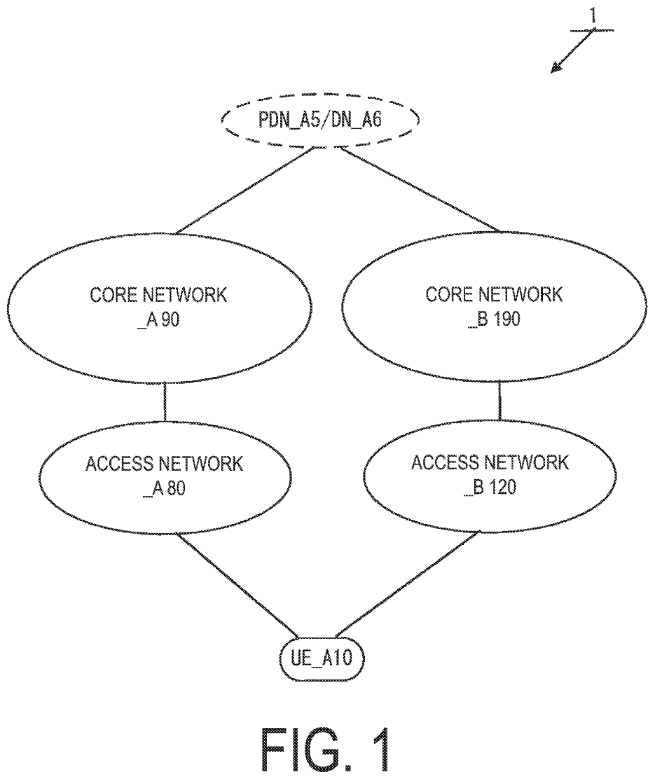

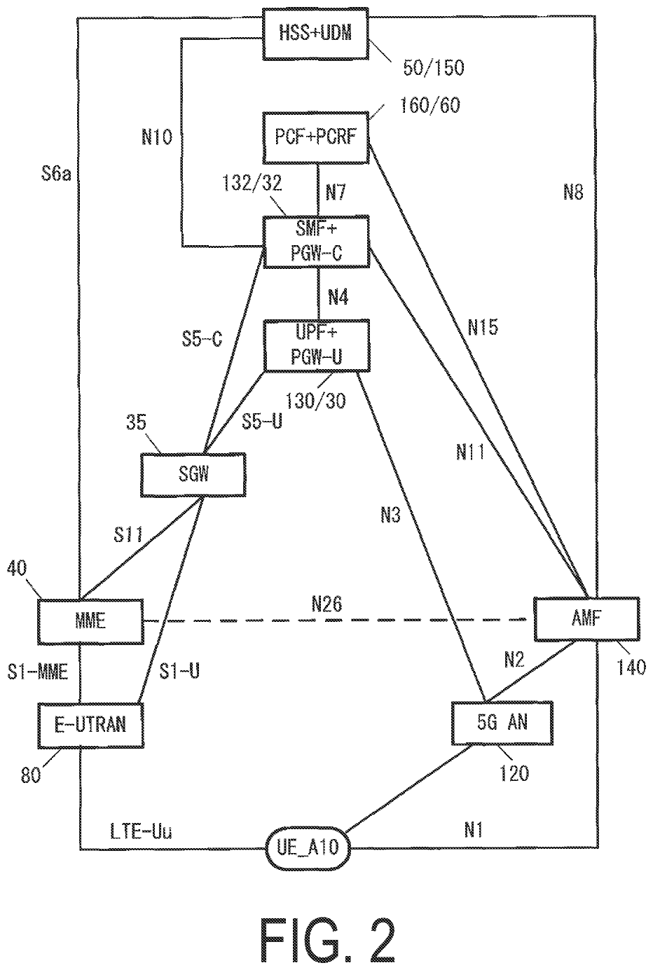

First, FIG. 1 is a diagram illustrating an overview of a mobile communication system 1 used in each embodiment, and FIG. 2 is a diagram illustrating a detailed configuration of the mobile communication system 1.

In the illustration of FIG. 1, the mobile communication system I includes a UE_A 10, an access network_A 80, a core network_A 90, a Packet Data Network (PDN)_A 5, an access network_B 120, a core network_B 190, and a Data Network (DN)_A 6.

In the following description, the symbols may be omitted, such as in a UE, an access network_A, a core network_A, a PDN, an access network_B, a core network_B, and a DN, in regard to these apparatuses and functions.

FIG. 2 illustrates apparatuses and functions such as a UE_A 10, an E-UTRAN 80, an MME 40, an SGW 35, a PGW-U 30, a PGW-C 32, a PCRF 60, an HSS 50, a 5G AN 120, an AMF 140, a UPF 130, an SMF 132, a PCF 160, and a UDM 150, and interfaces for connecting these apparatuses and functions to each other.

In the following, regarding these apparatuses and functions, the symbols may be simplified like the UE, E-UTRAN, MME, SGW, PGW-C, PCRF, HSS, 5G AN, AMF, UPF, SMF, PCF, and UDM.

Note that an Evolved Packet System (EPS) that is a 4G system includes the access network_A and the core network_A and may further include the UE and/or the PDN. A 5G System (5GS) that is a 5G system includes the UE, the access network_B, and the core network_B and may further include the DN.

The UE is an apparatus that can be connected to a network service over 3GPP access (also referred to as a 3GPP access network or a 3GPP AN) and/or non-3GPP access (also referred to as a non-3GPP access network or a non-3GPP AN). The UE may be a terminal apparatus capable of performing radio communication, such as a mobile phone and a smartphone, and may be a terminal apparatus that can be connected to both the EPS and the 5GS. The UE may include a Universal Integrated Circuit Card (UICC) and an Embedded UICC (eUICC). Note that the UE may be referred to as a user equipment or may be referred to as a terminal apparatus.

The access network_A corresponds to an Evolved Universal Terrestrial Radio Access Network (E-UTRAN) and/or a radio LAN access network. In the E-UTRAN, one or more evolved Node Bs (eNBs) 45 are deployed. Note that in the following description, the symbol of the eNB 45 may be omitted such as in an eNB. In a case that there are multiple eNBs, the eNBs are connected to each other via, for example, an X2 interface. In the radio LAN access network, one or more access points are deployed.

The access network_B corresponds to a 5G access network (5G AN). The 5G AN includes an NG Radio Access Network (NG-RAN) and/or a non-3GPP access network. In the NG-RAN, one or more NR NodeBs (gNBs) 122 are deployed. Note that in the following description, the symbol of the gNB 122 may be omitted, such as in an eNB. The gNB is a node that provides a New Radio (NR) user plane and control plane to the UE, and is a node that is connected to a 5GCN via the NG interface (including the N2 interface or the N3 interface). In other words, the gNB is a base station apparatus newly designed for the 5GS and has functions different from those of the base station apparatus (eNB) used in the EPS that is a 4G system. In a case that there are multiple gNBs, the gNBs are connected to each other via, for example, an Xn interface.

In the following description, the E-UTRAN and the NG-RAN may be referred to as 3GPP access. The radio LAN access network and the non-3GPP AN may be referred to as non-3GPP access. The nodes deployed in the access network_B may also be collectively referred to as NG-RAN nodes.

In the following description, the access network_A, and/or the access network_B, and/or an apparatus included in the access network_A, and/or an apparatus included in the access network_B may be referred to as an access network or an access network apparatus.

The core network corresponds to an Evolved Packet Core (EPC). In the EPC, for example, a Mobility Management Entity (MME), a Serving Gateway (SGW), a Packet Data Network Gateway (PGW)-U, a PGW-C, a Policy and Charging Rules Function (PCRF), a Home Subscriber Server (HSS), and the like are deployed.

The core network_B corresponds to a 5G Core Network (5GCN). In the 5GCN, for example, an Access and Mobility Management Function (AMF), a User Plane Function (UPF), a Session Management Function (SMF), a Policy Control Function (PCF), a Unified Data Management (UDM), and the like are deployed. Here, the 5GCN may be referred to as a 5GC.

In the following, the core network_A, and/or the core network_B, an apparatus included in the core network_A, and/or an apparatus included in the core network_B may be referred to as a core network or a core network apparatus.

The core network (the core network_A and/or the core network_B) may refer to an IP mobile communication network operated by a mobile communication operator (Mobile Network Operator MNO)) connecting the access network (the access network_A and/or the access network_B) and the PDN and/or the DN, may refer to a core network for a mobile communication operator that operates and manages the mobile communication system 1, or may be a core network for a virtual mobile communication operator and a virtual mobile communication service provider such as a Mobile Virtual Network Operator (MVNO) and a Mobile Virtual Network Enabler (MVNE).

FIG. 1 illustrates a case that the PDN and the DN are the same; however the PDN and the DN may be different. The PDN may be a Data Network (DN) that provides communication services for the UE. Note that the DN may be configured as a packet data service network or may be configured for each service. In addition, the PDN may include a connected communication terminal. Thus, “to be connected to the PDN” may mean “to be connected to a communication terminal and a server apparatus deployed in the PDN”. In addition, “to transmit and/or receive user data to and/or from the PDN” may mean “to transmit and/or receive user data to and/or from a communication terminal and a server apparatus deployed in the PDN”. Note that the PDN may be referred to as a DN, and the DN may be referred to as a PDN.

In the following, at least some of the access network_A, the core network_A, the PDN, the access network_B, the core network_B, and the DN, and/or one or more apparatuses included in these may be referred to as a network or a network apparatus. In other words, the expression that “the network and/or the network apparatus transmits and/or receives a message and/or performs a procedure” means that “at least some of the access network_A, the core network_A. the PDN, the access network_B, the core network_B, and the DN, and/or one or more apparatuses included in these transmit and/or receive a message and/or perform a procedure”.

The UE can be connected to the access network. The UE can be connected to the core network over the access network. In addition, the UE can be connected to the PDN or the DN over the access network and the core network. In other words, the UE can transmit and/or receive (communicate) user data to and/or from the PDN or the DN. In a case that user data is transmitted and/or received, not only Internet Protocol (IP) communication but also non-IP communication may be used.

Here, the IP communication refers to data communication using the IP, and data is transmitted and/or received using IP packets. The IP packet includes an IP header and a payload part. In the payload part, data transmitted and/or received by the apparatuses and functions included in the EPS and the apparatuses and functions included in the 5GS may be included. The non-IP communication refers to data communication not using the IP, and data is transmitted and/or received in a form different from the structure of the IP packets. For example, non-IP communication may be data communication implemented through transmission and/or reception of application data not to which an IP header is not added, or user data transmitted and/or received by the UE may be transmitted and/or received with another header such as a MAC header and an Ethernet (trade name) frame header added.

### 2. Configuration of Each Apparatus

Next, a configuration of each apparatus (the UE, and/or the access network apparatus, and/or the core network apparatus) used in each embodiment will be described with reference to the drawings. Note that each apparatus may be configured as physical hardware, may be configured as logical (virtual) hardware configured in general-purpose hardware, or may be configured as software. At least a part (including all) of the functions of each apparatus may be configured as physical hardware, logical hardware, or software.

Note that each storage unit (a storage unit_A 340, a storage unit_A 440, a storage unit_B 540, a storage unit_A 640, and a storage unit_B 740) in each apparatus and function to be described later includes, for example, a semiconductor memory, a Solid State Drive (SSD), a Hard Disk Drive (HDD), or the like. Each storage unit can store not only information originally configured at the time of being shipped, but also various pieces of information transmitted and/or received to and/or from apparatuses and functions (for example, the UE, and/or the access network apparatus, and/or the core network apparatus, and/or the PDN, and/or the DN) other than the apparatus and functions of each storage unit. Each storage unit can store identification information, control information, flags, parameters, and the like included in a control message transmitted and/or received in various communication procedures to be described later. Each storage unit may store these pieces of information for each UE. In a case that each storage unit performs interworking between the 5GS and the EPS, each storage unit can store a control message and user data transmitted and/or received to and/or from the apparatuses and functions included in the 5GS and/or the EPS. In this case, not only information transmitted and/or received over the N26 interface but also information transmitted and/or received without using the N26 interface can be stored.

### 2.1. Apparatus Configuration of UE

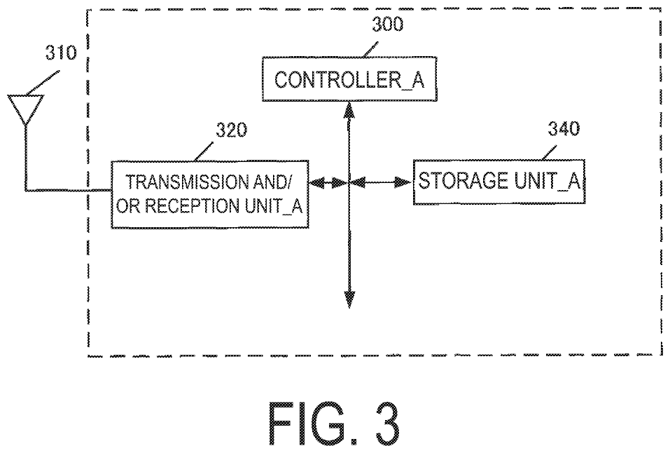

First, an apparatus configuration example of the User Equipment (UE) will be described with reference to FIG. 3. The UE includes a controller_A 300, an antenna 310, a transmission and/or reception unit_A 320, and a storage unit_A 340. The controller_A 300, the transmission and/or reception unit_A 320, and the storage unit_A 340 are connected via a bus. The transmission and/or reception unit_A 320 connects to the antenna 310.

The controller_A 300 is a function unit that controls the entire operations and functions of the UE. The controller_A 300 reads and performs various programs stored in the storage unit_A 340 as necessary, and thereby implements various types of processing in the UE.

The transmission and/or reception unit_A 320 is a function unit for performing radio communication with the base station apparatus (the eNB or the gNB) in the access network via the antenna. In other words, with the use of the transmission and/or reception unit_A 320, the UE can transmit and/or receive user data and/or control information to and/or from the access network apparatus, and/or the core network apparatus, and/or the PDN, and/or the DN.

Detailed description is given with reference to FIG. 2. With the use of the transmission and/or reception unit_A 320, the UE can communicate with the base station apparatus (eNB) in the E-UTRAN over the LTE-Uu interface. The UE can communicate with the base station apparatus (gNB) in the 5G AN with the use of the transmission and/or reception unit_A, 320. The UE can transmit and/or receive a Non-Access-Stratum (NAS) message to and/or from the AMF over the N1 interface with the use of the transmission and/or reception unit_A 320. Note that the N1 interface is a logical interface, and thus communication between the UE and the AMF is actually performed over the 5G AN.

The storage unit_A 340 is a function unit for storing programs, user data, control information, and the like necessary for each operation of the UE.

### 2.2. Apparatus Configuration of gNB

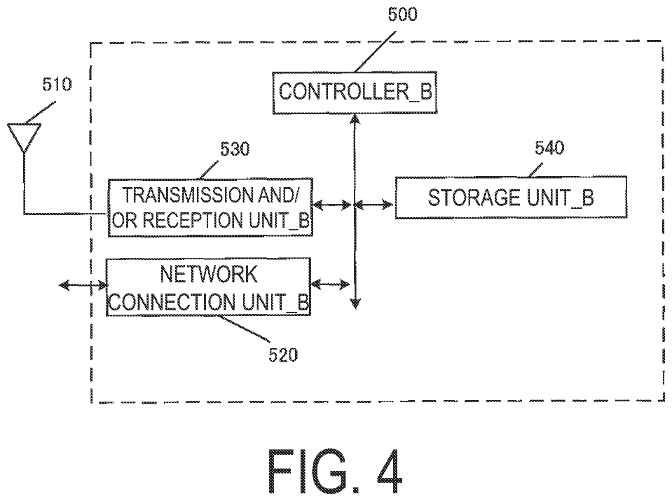

Next, an apparatus configuration example of the gNB will be described with reference to FIG. 4. The gNB includes a controller_B 500, an antenna 510, a network connection unit_B 520, a transmission and/or reception unit_B 530, and a storage unit_B 540. The controller_B 500, the network connection unit_B 520, the transmission and/or reception unit_B 530, and the storage unit_B 540 are connected via a bus. The transmission and/or reception unit_B 530 connects to the antenna 510.

The controller_B 500 is a function unit that controls the entire operations and functions of the gNB. The controller_B 500 reads and performs various programs stored in the storage unit_B 540 as necessary, and thereby implements various types of processing in the gNB.

The network connection unit_B 520 is a function unit for the gNB to communicate with the AMF and/or the UPF. In other words, with the use of the network connection unit_B 520, the gNB can transmit and/or receive user data and/or control information to and/or from the AMF and/or the UPF.

The transmission and/or reception unit_B 530 is a function unit for performing radio communication with the UE via the antenna 510. In other words, with the use of the transmission and/or reception unit_B 530, the gNB can transmit and/or receive user data and/or control information to and/or from the UE.

Detailed description is given with reference to FIG. 2. With the use of the network connection unit_B 520, the gNB in the 5G AN can communicate with the AMF over the N2 interface and can communicate with the UPF over the N3 interface, The gNB can communicate with the UE with the use of the transmission and/or reception unit_B 530.

The storage unit_B 540 is a function unit for storing programs, user data, control information, and the like necessary for each operation of the gNB.

### 2.3. Apparatus Configuration of AMF

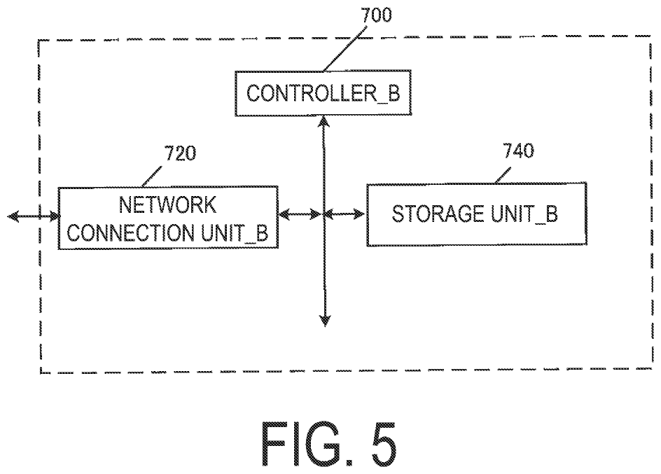

Next, an apparatus configuration example of the AMF will be described with reference to FIG. 5. The AMF includes a controller_B 700, a network connection unit_B 720, and a storage unit_B 740. The controller_B 700, the network connection unit_B 720, and the storage unit_B 740 are connected via a bus. The AMF may be a node that handles the control plane.

The controller_B 700 is a function unit that controls the entire operations and functions of the AMF. The controller_B 700 reads and performs various programs stored in the storage unit_B 740 as necessary, and thereby implements various types of processing in the AMF.

The network connection unit_B 720 is a function unit for the AMF to connect to the base station apparatus (gNB), and/or the SMF, and/or the PCF, and/or the UDM, and/or the SCEF in the 5G AN. In other words, with the use of the network connection unit_B 720, the AMF can transmit and/or receive user data and/or control information to and/or from the base station apparatus (gNB), and/or the SMF, and/or the PCF, and/or the UDM, and/or the SCEF in the 5G AN.

Detailed description is given with reference to FIG. 2. With the use of the network connection unit_A 620, the AMF in the 5GCN can communicate with the gNB over the N2 interface, can communicate with the UDM over the N8 interface, can communicate with the SMF over the N11 interface, and can communicate with the PCF over the N15 interface. The AMF can transmit and/or receive a NAS message to and/or from the UE over the N1 interface with the use of the network connection unit_A 620. Note that the N1 interface is a logical interface, and thus communication between the UE and the AMF is actually performed over the 5G AN. In a case that the AMF supports the N26 interface, the AMF can communicate with the MME over the N26 interface with the use of the network connection unit_A 620.

The storage unit_B 740 is a function unit for storing programs, user data, control information, and the like necessary for each operation of the AMF.

Note that the AMF has a function of exchanging a control message with the RAN using the N2 interface, a function of exchanging a NAS message with the UE using the N1 interface, a function of performing encryption and integrity protection of a NAS message, a Registration management (RM) function, a Connection management (CM) function, a Reachability management function, a Mobility management function for the UE or the like, a function of transferring a Session Management (SM) message between the UE and the SMF, an Access Authentication (Access Authorization) function, a security anchor function (Security Anchor Functionality (SEA)), a Security Context Management (SCM) function, a function of supporting the N2 interface for a Non-3GPP Interworking Function (N3IWF), a function of supporting transmission and/or reception of a NAS signal with the UE via the N3IWF, a function of authenticating the UE connected via the N3IWF, and the like.

In registration management, an RM state for each UE is managed. The RM state may be synchronized between the UE and the AMF. The RM state includes a deregistered state (RM-DEREGISTERED state) and a registered state (RM-REGISTERED state). In the RM-DEREGISTERED state, the UE is not registered in the network, and thus the AMF is in a state of being unable to reach the UE, because a UE context in the AMF does not have valid location information and routing information for the UE. In the RM-REGISTERED state, the UE is registered in the network, and thus the UE can receive a service that requires registration in the network. Note that the RM state may be referred to as a 5GMM state. In this case, the RM-DEREGISTERED state may be referred to as a 5GMM-DEREGISTERED state, and the RM-REGISTERED state may be referred to as a 5GMM-REGISTERED state.

In other words, 5GMM-RIGISTERED may be a state in which each apparatus establishes a 5GMM context, or may be a state in which each apparatus establishes a PDU session context. Note that, in a case that each apparatus is 5GMM-REGISTERED, the UE_A 10 may start transmission and/or reception of user data and a control message, or may respond to paging. In addition, note that, in a case that each apparatus is 5GMM-REGISTERED, the UE_A 10 may perform a registration procedure other than a registration procedure for initial registration, and/or a service request procedure.

In addition, 5GMM-DEREGISTERED may be a state in which each apparatus does not establish the 5G MM context, may be a state in which the location information of the UE_A 10 is not known to the network, or may be a state in which the network is in a state of being unable to reach the UE_A 10. Note that, in a case that each apparatus is 5GMM-DEREGISTERED, the UE_A 10 may initiate the registration procedure, or may perform the registration procedure to thereby establish the 5GMM context.

In connection management, a CM state for each UE is managed. The CM state may be synchronized between the UE and the AMF. The CM state includes a non-connected state (CM-IDLE state) and a connected state (CM-CONNECTED state). In the CM-IDLE state, the UE is in the RM-REGISTERED state, but does not have NAS signaling connection established with the AMF via the N1 interface. In the CM-IDLE state, the UE does not have connection of the N2 interface connection) and connection of the N3 interface (N3 connection). In contrast, in the CM-CONNECTED state, the UE has NAS signaling connection established with the AMF via the N1 interface. In the CM-CONNECTED state, the UE may have connection of the N2 interface (N2 connection) and/or connection of the N3 interface (N3 connection).

In addition, in connection management, management may be performed separately for the CM state in 3GPP access and the CM state in non-3GPP access. In this case, the CM state in 3GPP access may include a non-connected state in 3GPP access (CM-IDLE state over 3GPP access) and a connected state in 3GPP access (CM-CONNECTED state over 3GPP access). In addition, the CM state in non-3GPP access may include a non-connected state in non-3GPP access (CM-IDLE state over non-3GPP access) and a connected state in non-3GPP access (CM-CONNECTED state over non-3GPP access). Note that the non-connected state may be referred to as an idle mode, and a connected state mode may be referred to as a connected mode.

Note that the CM state may be referred to as a 5GMM mode. In this case, the non-connected state may be referred to as a 5GMM non-connected mode (5GMM-IDLE mode), and the connected state may be referred to as a 5GMM connected mode (5GMM-CONNECTED mode). In addition, the non-connected state in 3GPP access may be referred to as a 5GMM non-connected mode in 3GPP access (5GMM-IDLE mode over 3GPP access), and the connected state in 3GPP access may be referred to as a 5GMM connected mode in 3GPP access (5GMM-CONNECTED mode over 3GPP access). In addition, the non-connected state in non-3GPP access may be referred to as a 5GMM non-connected mode in non-3GPP access (5GMM-IDLE mode over non-3GPP access), and the connected state in non-3GPP access may be referred to as a 5GMM connected mode in non-3GPP access (5GMM-CONNECTED mode over non-3GPP access). Note that the 5GMM non-connected mode may be referred to as an idle mode, and the 5GMM connected mode may be referred to as a connected mode.

One or more AMFs may be deployed in the core network_B. The AMF may be an NF that manages one or more Network Slice Instances (NSIs). The AMF may be a common CP function (Common Control Plane Network Function (CPNF) (CCNF)) shared among multiple NSIs.

Note that, in a case that the UE connects to the 5GS over non-3GPP access, the N3IWF is an apparatus deployed and/or a function allocated between non-3GPP access and the 5GCN.

### 2.4. Apparatus Configuration of SMF

Next, an apparatus configuration example of the SMF will be described with reference to FIG. 5. The SMF includes a controller_B 700, a network connection unit_B 720, and a storage unit_B 740. The controller_B 700, the network connection unit_B 720, and the storage unit_B 740 are connected via a bus. The SMF may be a node that handles the control plane.

The controller_B 700 is a function unit that controls the entire operations and functions of the SMF. The controller_B 700 reads and performs various programs stored in the storage unit_B 740 as necessary, and thereby implements various types of processing in the SMF.

The network connection unit_B 720 is a function unit for the SMF to connect to the AMF, and/or the UPF, and/or the PCF, and/or the UDM. In other words, with the use of the network connection unit_B 720, the SMF can transmit and/or receive user data and/or control information to and/or from the AMF, and/or the UPF, and/or the PCF, and/or the UDM.

Detailed description is given with reference to FIG. 2. With the use of the network connection unit_A 620, the SMF in the 5GCN can communicate with the AMF over the N11 interface, can communicate with the UPF over the N4 interface, can communicate with the PCF via the N7 interface, and can communicate with the UDM over the N10 interface.

The storage unit_B 740 is a function unit for storing programs, user data, control information, and the like necessary for each operation of the SMF.

The SW has a Session Management function such as establishment, modification, and release of a PDU session, a function of IP address allocation to the UE and management thereof, a function of selection and control of the UPF, a function of configuring the UPF for routing traffic to an appropriate destination (transmission destination), a function of transmitting and/or receiving an SM part of a NAS message, a function of issuing a notification about arrival of downlink data (Downlink Data Notification), a function of providing SM information specific to the AN (for each AN) that is transmitted to the AN through the AMF via the N2 interface, a function of determining a Session and Service Continuity mode (SSC mode) for a session, a roaming function, and the like.

### 2.5. Apparatus Configuration of UPF

Next, an apparatus configuration example of the UPF will be described with reference to FIG. 5. The UPF includes a controller_B 700, a network connection unit_B 720, and a storage unit_B 740. The controller_B 700, the network connection unit_B 720, and the storage unit_B 740 are connected via a bus. The UPF may be a node that handles the control plane.

The controller_B 700 is a function unit that controls the entire operations and functions of the UPF. The controller_B 700 reads and performs various programs stored in the storage unit_B 740 as necessary, and thereby implements various types of processing in the UPF.

The network connection unit_B 720 is a function unit for the UPF to connect to the base station apparatus (gNB), and/or the SMF, and/or the DN in the 5G AN. In other words, with the use of the network connection unit_B 720, the UPF can transmit and/or receive user data and/or control information to and/or from the base station apparatus (gNB), and/or the SMF, and/or the DN in the 5G AN.

Detailed description is given with reference to FIG. 2, With the use of the network connection unit_A 620, the UPF in the 5GCN can communicate with the gNB over the N3 interface, can communicate with the SMF over the N4 interface, can communicate with the DN over the N6 interface, and can communicate with another UPF over the N9 interface.

The storage unit_B 740 is a function unit for storing programs, user data, control information, and the like necessary for each operation of the UPF.

The UPF has a function as an anchor point for intra-RAT mobility or inter-RAT mobility, a function as an external PDU session point to be mutually connected with the DN (that is, a function of transferring user data as a gateway between the DN and the core network_B), a function of routing and transferring packets, an Uplink Classifier (UL CL) function of supporting routing of multiple traffic flows for one DN, a Branching point function of supporting a multi-homed PDU session, a Quality of Service (QoS) processing function for the user plane, a function of verifying uplink traffic, a function of triggering buffering of downlink packets and Downlink Data Notification, and the like.

The UPF may be a gateway for IP communication and/or non-1P communication. The UPF may have a function of transferring IP communication, or may not have a function of converting non-IP communication and IP communication. In addition, multiple deployed gateways may be gateways for connecting the core network_B and a single DN. Note that the UPF may have connectivity with another NF, and may connect to each apparatus via another NF.

Note that the user plane refers to user data that is transmitted and/or received between the UE and the network. The user plane may be transmitted and/or received using a PDN connection or a PDU session. In addition, in a case of the EPS, the user plane may be transmitted and/or received using the LTE-Uu interface, and/or the S1-U interface, and/or the S5 interface, and/or the S8 interface, and/or the SGi interface. In addition, in a case of the 5GS, the user plane may be transmitted and/or received over the interface between the UE and the NG RAN, and/or the N3 interface, and/or the N9 interface, and/or the N6 interface. The user plane may be hereinafter referred to as a U-Plane.

In addition, the control plane refers to a control message that is transmitted and/or received in order to perform communication control of the UE or the like. The control plane may be transmitted and/or received using Non-Access-Stratum (NAS) signaling connection between the UE and the MME. In addition, in a case of the EPS, the control plane may be transmitted and/or received using the LTE-Uu interface and the S1-MME interface. In addition, in a case of the 5GS, the control plane may be transmitted and/or received using the interface between the UE and the NG RAN and the N2 interface. The control plane may be hereinafter referred to as a control plane, or may be hereinafter referred to as a C-Plane.

In addition, the User Plane (U Plane (UP)) may be a communication path for transmitting and/or receiving user data, and may include multiple bearers. In addition, the Control Plane (C-Plane (CP)) may be a communication path for transmitting and/or receiving a control message, and may include multiple bearers.

2.6. Description of Other Apparatuses and/or Functions

Next, other apparatuses and/or functions will be described.

The PCF has a function of providing a policy rule and the like.

The UDM has an authentication information processing (Authentication credential processing) function, a user identification processing function, an access authentication function, a registration/mobility management function, a subscriber information management (subscription management) function, and the like.

The PCRF is connected to the PGW and/or the PDN, and has a function of performing QoS management for data delivery and the like. For example, the PCRF performs management of the QoS of a communication path between the UE_A 10 and the PDN. In addition, the PCRF may be an apparatus that creates and/or manages a Policy and Charging Control (PCC) rule and/or a routing rule used by each apparatus at the time of transmitting and/or receiving user data.

The HSS is connected to the_MME and/or the SCEF, and has a function of performing management of subscriber information and the like. The subscriber information of the HSS is referred to in a case of, for example, access control of the MME. In addition, the HSS may be connected to a location management device different from the MME.

The SCEF is connected to the DN and/or the PDN, the_MME, and the HSS, and has a function as a relay apparatus that transfers user data as a gateway connecting the DN and/or the PDN and the core network_A and the like. Note that the SCEF may be a gateway for non-IP communication. In addition, the SCEF may have a function of converting non-IP communication and IP communication. Multiple such gateways may be deployed in the core network_A. The SCEF may be configured either outside or inside the core network.

### 3. Description of Terms, Pieces of Identification Information, and Procedures Used in Each Embodiment

Terms, pieces of identification information, and procedures, at least one of which is used in each embodiment, will be described in advance.

### 3.1, Description of Terms and Pieces of Identification Information Used in Each Embodiment

First, highly technical terms and pieces of identification information used in procedures that are used in each embodiment will be described in advance.

A network refers to at least some of the access network_B, the core network_B, and the DN. One or more apparatuses included in at least a part of the access network_B, the core network_B, and the DN may be referred to as a network or a network apparatus. In other words, “a network transmits and/or receives a message and/or performs processing” may mean “an apparatus (a network apparatus and/or a control apparatus) in the network transmits and/or receives the message and/or performs the processing”, Conversely, “an apparatus in a network transmits and/or receives a message and/or performs processing” may mean “the network transmits and/or receives the message and/or performs the processing”.

Furthermore, the network may refer to a Public Land Mobile Network (PLMN), or may refer to an NPN described below. In addition, the expression “UE performs network selection” may indicate that the UE makes PLMN selection or that the UE makes SNPN selection.

A registered PLMN refers to a PLMN with which the UE is registered.

An equivalent PLMN refers to a PLMN treated like the same PLMN as any PLMN in the network. For example, the equivalent PLMN may be one or multiple PLMNs treated like the registered PLMN.

A session management (SM) message (also referred to as a Non-Access-Stratum (NAS) SM message) may be a NAS message used in a procedure for SM, or may be a control message transmitted and/or received between the UE_A 10 and the SMF_A 230 via the AMF_A 240, In addition, the SM message may include a PDU session establishment request message, a PDU session establishment accept message, a PDU session complete message, a PDU session reject message, a PDU session modification request message, a PDU session modification accept message, a PDU session modification response message, and the like. The procedure for SM may include a PDU session establishment procedure.

A 5G System (5GS) service may be a connection service provided using the core network_B 190. In addition, the 5GS service may be a service different from an EPS service, or may be a service similar to the EPS service.

A non 5GS service may be a service other than the 5GS service and may include an EPS service and/or a non EPS service.

A single registration mode is a mode in which the UE_A 10 maintains a common registered state for the 5GMM state and an EMM state in a case that the UE_A 10 can use an N1 mode and an S1 mode.

A dual registration mode is a mode in which the UE_A 10 maintains independent registered states for the 5GMM state and the EMM state in a case that the N1 mode and the S1 mode are available. Note that, for the dual registration mode, the UE_A 10 may be registered with the network only for the N1 mode (in other words, registered only with the 5GC), or may be registered with the network only for the S1 mode (registered only with the EPC), or may be registered with the network both for the N1 mode and for the S1 mode (registered both with the 5GC and with the EPC).

For interworking between the 5GS and the EPC, a UE supporting both the 5GC and the EPC NAS can operate in the single registration mode or the dual registration mode.

The S1 mode is a mode in which the UE_A 10 is allowed to access the EPC via the E-UTRAN. In other words, the S1 mode may be a mode in which a message is transmitted and/or received using the S1 interface. Note that the S1 interface may include the S1-MME interface and the S1-U interface.

The N1 mode is a mode in which the UE_A 10 is allowed to access the 5GC via the 5G access network. In other words, the N1 node may be a mode in which a message is transmitted and/or received using the N1 interface.

An Access Point Name (APN) may be identification information for identifying the core network and/or an external network such as the PDN. In addition, the APN can also be used as information for selecting a gateway such as the PGW_A 30/UPF_A 235 connecting the core network_A 90.

A Packet Data Network (PDN) type indicates a type of PDN connection and includes IPv4, IPv6, IPv4v6, and non-IP. In a case that IPv4 is specified, it is indicated that transmission and/or reception of data is performed using IPv4. In a case that IPv6 is specified, it is indicated that transmission and/or reception of data is performed using IPv6. In a case that IPv4v6 is specified, it is indicated that transmission and/or reception of data is performed using IPv4 or IPv6. In a case that non-IP is specified, it is indicated that communication is performed using a communication method other than the IP, not communication using the IP.

Although Protocol Data Unit/Packet Data Unit (PDU) session can be defined as a relationship between the DN that provides a PDU connectivity service and the UE, the PDU session may be connectivity established between the UE and an external gateway. In the 5GS, the UE establishes a PDU session via the access network_B and the core network_B, and can thereby perform transmission and/or reception of user data to and/or from the DN by using the PDU session. Here, the external gateway may be a UPF, an SCEF, or the like. The UE can perform transmission and/or reception of user data to and/or from an apparatus deployed in the DN, such as an application server, by using a PDU session.

Note that each apparatus (the UE, and/or the access network apparatus, and/or the core network apparatus) may associate one or more pieces of identification information with PDU session(s) for management. Note that these pieces of identification information may include one or more of a DNN, a QoS rule, a PDU session type, application identification information, NSI identification information, access network identification information, and an SSC mode, and may further include other pieces of information. hi addition, in a case that multiple PDU sessions are established, pieces of identification information associated with the PDU sessions may have the same or different contents.

The Data Network Name (DNN) may be identification information for identifying the core network and/or an external network such as the DN. In addition, the DNN can also be used as information for selecting a gateway such as the PGW_A 30/UPF_A 235 connecting the core network_B 190. In addition, the DNN may correspond to an Access Point Name (APN).

A Protocol Data Unit/Packet Data Unit (PDU) session type indicates a type of PDU session and includes IPv4, IPv6, Ethernet, and Unstructured. In a case that IPv4 is specified, it is indicated that transmission and/or reception of data is performed using IPv4. In a case that IPv6 is specified, it is indicated that transmission and/or reception of data is performed using IPv6. In a case that Ethernet is specified, it is indicated that transmission and/or reception of an Ethernet frame is performed. Alternatively, Ethernet may indicate that communication using the IP is not performed. In a case that Unstructured is specified, it is indicated that data is transmitted and/or received to and/or from an application server in the DN or the like by using Point-to-Point (P2P) tunneling technique. For the P2P tunneling technique, for example, UDP/IP encapsulation technique may be used. Note that the PDU session type may include the IP, in addition to the above. The IP can be specified in a case that the UE can use both of IPv4 and IPv6.

A network slice (NS) is a logical network that provides specific network capability and network characteristics. The UE and/or the network can support the network slice (NW slice (NS)) in the 5GS.

A network slice instance (NSI) includes a set of an instance (entity) of a network function (NF) and necessary resources and forms a network slice to be allocated. Here, the NF is a processing function in a network, and is adopted or defined in 3GPP, The NSI is an entity of one or more NSs configured in the core network_B. The NSI may include a virtual Network Function (NF) generated using a Network Slice Template (NST). Here, the NST is associated with a resource request for provision of a requested communication service and capability, and is a logical expression of one or more NFs. In other words, the NSI may be a set of multiple NFs in the core network_B 190. The NSI may be a logical network configured for classifying user data to be delivered depending on a service or the like. In the NS, one or more NFs may be configured. The NF configured in the NS may or may not be an apparatus shared with another NS. The UE and/or the apparatus in the network can be allocated to one or more NSs, based on an NSSAI, and/or an S-NSSAI, and/or a UE usage type, and/or registration information such as one or more NSI IDs, and/or an APN. Note that the UE usage type is a parameter value included in registration information of the UE, which is used for identifying the NSI. The UE usage type may be stored in the HSS. The AMF may select the SMF and the UPF, based on the UE usage type.

The Single Network Slice Selection Assistance Information (S-NSSAI) is information for identifying the NS. The S-NSSAI may include only a Slice/Service type (SST), or may include both of an SST and a Slice Differentiator (SD). Here, the SST is information indicating operation of the NS expected in terms of functions and services. The SD may be information for interpolating an SST in a case of selecting one NSI out of multiple NSIs indicated by the SST. The S-NSSAI may be information unique to each PLMN or may be standard information common to the PLMNs. The network may store one or more S-NSSAIs in the registration information of the UE as default S-NSSAI(s). Note that, in a case that the S-NSSAI is a default S-NSSAI, and the UE does not transmit to a network a valid S-NSSAI in a registration request message, the network may provide an NS related to the UE.

The Network Slice Selection Assistance information (NSSAI) is a set of S-NSSAIs. Each S-NSSAI included in the NSSAI is information for assisting the access network or the core network to select the NSI. The UE may store the NSSAI allowed by the network for each PLMN. The NSSAI may be information used for selecting the AMF.

The Session and Service Continuity (SSC) mode indicates a mode of Session and. Service Continuity supported by the system and/or each apparatus in the 5G system (5GS). More specifically, the SSC mode may be a mode indicating a type of session and service continuity supported by a PDU session that is established between the UE_A 10 and the UPF. Note that the SSC mode may be a mode indicating the type of session and service continuity configured for each PDU session. Furthermore, the SSC mode may include three modes of SSC mode 1, SSC mode 2, and SSC mode 3. Note that the SSC mode associated with the PDU session need not be changed while the PDU session is alive.

5GMM-CONNECTED mode with RRC inactive indication is a state indicating that the state of the NAS layer is a connected state although the RRC layer is in an inactive state. In other words, 5GMM-CONNECTED mode with RRC inactive indication is a state in which a radio bearer is released while NAS signaling connection and/or a context of the NAS signaling connection is maintained.

Note that supporting 5GMM-CONNECTED mode with RRC inactive indication may mean that maintaining of a state of the NAS layer in the connected state is supported even in a case that a notification indicating that the RRC layer has become inactive is received from a lower layer. In addition, using 5GMM-CONNECTED mode with RRC inactive indication may mean that the state of the NAS layer is maintained in the connected state even in a case that a notification indicating that the RRC layer has become inactive is received from a lower layer.

A tracking area is a single or multiple ranges that can be expressed using the location information of the UE_A 10 managed by the core network. The tracking area may include multiple cells. In addition, the tracking area may be an area in which a control message such as paging is broadcast, or may be an area in which the UE_A 10 can move without performing a handover procedure. In addition, the tracking area may be a routing area, or may be a location area. The tracking area may be any area as long as the area is similar to these. The tracking area may be hereinafter a Tracking Area (TA).

A TA list is a list including one or multiple TAs allocated to the UE_A 10 by the network. Note that while the UE_A 10 is moving within one or multiple TAs included in the TA list, the UE_A 10 may be able to move without performing a tracking area update procedure. In other words, for the UE_A 10, the TA list may be an information group indicating an area in which the UE_A 10 can move without performing the tracking area update procedure. Note that the TA list may be expressed as a TAI list including one or multiple Tracking area identities (TAIs), and the TAI list may hereinafter refer to a TA list.

The LADN (Local Area Data Network) refers to a DN to which the UE can connect only at a specific location, and provides connectivity for a specific DNN (that is, an LADN DNN). The LADN may be a DN which can be connected at a specific location by using a PDU session associated with a particular DNN. Furthermore, the LADN may be a DN which can be connected at a specific location by using a PDU session associated with a combination of a specific DNN and a specific S-NSSAI.

LADN information is information related to the LADN. The LADN information may be information indicating a specific LADN that can be used by the UE. The LADN information may include an LADN DNN and LADN service area information. More specifically, the LADN information may include one or more pieces of information that are present in each LADN (hereinafter referred to as information indicating the LADN). Furthermore, the information indicating the LADN may include the LADN DNN and the LADN service area information. In this regard, the LADN DNN may be information for identifying an LADN, information indicating a DN regarded as an LADN, or a DNN used in a case that a PDU session is established for the LADN.

Note that in a case that the LADN information is conventional LADN information, the LADN information may be information with the configuration described above. Specifically, in a case that the LADN information is conventional LADN information, the LADN service area may be a conventional LADN service area.

On the contrary, in a case that the LADN information is extended LADN information, the LADN information may be information with a configuration obtained by partially extending the configuration described above. Specifically, in the case that the LADN information is the extended LADN information, the LADN service area may be an extended LADN service area. Furthermore, in the case that the LADN information is the extended LADN information, the information indicating the LADN may further include information indicating a duration in which the LADN service area is valid, and/or information indicating the granularity of the LADN service area. Furthermore, in the case that the LADN information is the extended LADN information, the information indicating the LADN may further include S-NSSAI.

Note that the LADN service area is an area in which a PDU session can be established for the LADN. The LADN service area may be an area in which connection to the LADN is enabled. Furthermore, the LADN service area may be an area indicated by LADN service area information. In this regard, the LADN service area information may be information for identifying an LADN service area, and may be provided as a set of tracking areas or as a TAI (Tracking area identity) list.

Note that in a case that the LADN service area is a conventional LADN service area, the LADN service area may be an area including a tracking area belonging to a registration area to which the UE is currently connected. In other words, in the case that the LADN service area is a conventional service area, the LADN service area may be an area including one or multiple tracking areas. In contrast, in the case that the LADN service area is an extended LADN service area, the LADN service area may be an area including the tracking area or an area covered by some base stations within the tracking area. Furthermore, in the case that the LADN service area is an extended LADN service area, the LADN service area may be an area of a size other than that of the area including the tracking area, or an area that does not depend on the tracking area. In other words, in the case that the LADN service area is an extended LADN service area, the LADN service area may be an area including one or multiple tracking areas, or an area different from the area including one or multiple tracking areas.

Furthermore, in a case that the LADN service area is an area including one or multiple tracking areas, the LADN service area information may be a tracking area ID list including one or multiple tracking area IDs. In contrast, in a case that the LADN service area is an area different from the area including one or multiple tracking areas, the LADN service area information may be information requiring assistance of the Radio Access Network (RAN), or information not requiring the assistance of the RAN. In this regard, the information requiring the assistance of the RAN may be information of a cell, or information of a base station. Furthermore, the information requiring the assistance of the RAN may be a cell ID or a base station ID. Furthermore, the information requiring the assistance of the RAN is not limited to the information described above, and may be information defined by the RAN. Moreover, the information not requiring the assistance of the RAN may be physical location information or location information that can be acquired by an application. Furthermore, the information not requiring the assistance of the RAN is not limited to the information described above, and may be information that can be acquired by other than the RAN. In this regard, the RAN may be expressed as an access network. In contrast, the access network may be referred to as the RAN.

The extension of the LADN service area may mean the use of an LADN service area with a granularity different from that of the conventional LADN service area. Furthermore, the extension of the LADN service area may mean the use of extended LADN information different from the conventional LADN information. Furthermore, the extension of the LADN service area may mean connection to an extended LADN that is different from the conventional LADN.

In other words, in a case that each apparatus supports the extension of the LADN service area, in addition to the conventional LADN service area, an extended LADN service area that is different from the conventional LADN service area may be adaptable. Furthermore, in the case that each apparatus supports the extension of the LADN service area, in addition to the conventional LADN information, extended LADN information that is different from the conventional LADN information may be available. Furthermore, in the case that each apparatus supports the extension of the LADN service area, connection can be made, besides to the conventional to an extended LADN that is different from the conventional LADN.

In contrast, in a case that a part of each apparatus does not support the extension of the LADN service area, the extended LADN service area need not be adaptable, and only the conventional LADN service area may be adaptable. Furthermore, in the case that a part of each apparatus does not support the extension of the LADN service area, the extended LADN information need not be available, and only the conventional LADN information may be available. Furthermore, in the case that a part of each apparatus does not support the extension of the LADN service area, connection to the extended LADN need not be enabled, and only the connection to the conventional LADN may be enabled.

In a case that each apparatus supports the restriction on the use of extension of the LADN service area, the extended LADN service area need not be adaptable, and only the conventional LADN service area may be adaptable. Furthermore, in a case that each apparatus supports the restriction on the use of extension of the LADN service area, the extended LADN information need not be available, and only the conventional LADN information may be available. Furthermore, in a case that each apparatus supports the restriction of the extension of the LADN service area, connection to the extended LADN need not be enabled, and only connection to the conventional LADN may be enabled.

In contrast, in a case that each apparatus does not support the restriction on the use of extension of the LADN service area, the extended LADN service area may also be adaptable. Furthermore, in a case that each apparatus does not support the restriction on the use of extension of the LADN service area, the extended LADN information may also be available. Furthermore, in a case that each apparatus does not support the restriction on the use of extension of the LADN service area, connection to the extended LADN may be enabled.

A PDU session for the LADN (PDU session for LADN) is a PDU session associated with a DNN associated with the LADN. The PDU session for the LADN may be a PDU session established with the LADN. In other words, the PDU session for the LADN may be a PDU session established between the UE and the LADN, or may be a PDU session used for user data communication between the UE and the LADN. Note that the PDU session for the LADN may be a PDU session that can be established only in the LADN service area. In other words, the UE may be able to establish a PDU session for the LADN by using a specific DNN at a specific location. Furthermore, in other words, the UE may be able to establish a PDU session for the LADN by using a combination of a specific DNN and specific S-NSSAI at a specific location.

Also, a Non-Public Network (NPN) is a non-public network used by specific users for specific purposes, such as by companies or for private utilization, instead of a purpose of general utilization. Two types of NPNs are available: a Standard-alone Non-Public Network (SNPN) and a Public network integrated NPN. Note that in a case that description NPN is provided below, it may mean both the SNPN and the Public network integrated NPN.

The SNPN is a network operated by an NPN operator and not affected by function units provided by the PLMN. In other words, the SNPN is an NPN-dedicated network that is independent from the PLMN opened to the public. The SNPN may be a network identified by an SNPN identity (SNPN ID). Note that the SNPN ID may be information including a combination of a PLAN ID and a Network identifier (MD), Note that the PLMN ID used for the SNPN ID may be information secured for a private network, and MCC included in the PLMN ID may be 999, for example. Furthermore, in a case that the UE is registered with the SNPN, the SNPN with which the UE is registered may be referred to as a registered SNPN or RSNPN (registered SNPN).

The Network identifier (MD) is information for identifying the network. The SNPN may be identified by information including a combination of the PLMN ID and the NID. The NID may be information that is unique in the SNPN or may be information that is unique worldwide.

A Public network integrated NPN is a network implemented using function units of the PLMN. In other words, the Public network integrated NPN is an NPN that is virtually implemented in the PLMN. Moreover, the Public network integrated NPN is an NPN that can be created via the PLMN. Note that the Public network integrated NPN may be implemented using a network slice function. Specifically, the Public network integrated NPN may be a network that can be implemented by using a network slice allocated for the NPN. In this case, the Public network integrated NPN may be identified by the S-NSSAI or may be identified by a combination of the S-NSSAI and a CAG ID.

Furthermore, the Public network integrated NPN may be implemented using the DN. Specifically, the Public network integrated NPN may be a network implemented by using the DN for the NPN. In this case, the Public network integrated NPN may be identified by the DNN or by a combination of the DNN and the CAG ID.

The Closed Access Groups (CAG) ID is information for identifying a group of subscribers who are allowed to connect to one or multiple cells associated with the CAG. The CAG may be a group identified by the CAG ID. The CAG is a group used in a case that the Public network integrated NPN is implemented by the network slice. The CAG may be used in order for the UE not to attempt to access the network slice allocated for the NPN, the UE being not allowed to use the NPN. Furthermore, the CAG ID is information that is unique within the PLMN.

An SNPN enable UE is a UE configured with the use of the SNPN. The SNPN enable UE may store at least one piece of information related to the SNPN. In other words, configuration information of the SNPN enable UE may include information indicating that the SNPN is available. Furthermore, the SNPN enable UE may support an SNPN access mode. In other words, the SNPN enable UE may operate in the SNPN access mode.

The SNPN access mode is a mode in which the SNPN is selected. The SNPN access mode may be a mode in which the UE is registered with the SNPN. Furthermore, the SNPN access mode may be a mode in which the UE is connected to the SNPN. In other words, the UE operating in the SNPN access mode may exclusively select the SNPN at the time of network selection. More specifically, the UE operating in the SNPN access mode may exclusively select, at the time of network selection, the SNPN operating via a Uu interface. In other words, the UE operating in the SNPN access mode may select the SNPN instead of the PLMN at the time of network selection. In this regard, the UE operating in the SNPN access mode may be expressed as a UE in the SNPN access mode. Furthermore, the UE in the SNPN access mode may be an SNPN enable UE.

The equivalent SNPN (equivalent PLMN) may be an SNPN treated like the same SNPN as any SNPN. For example, the equivalent SNPN may be one or multiple SNPNs treated similarly to registered SNPNs.

Furthermore, the equivalent SNPN may be a PLMN treated like the same SNPN as any SNPN. For example, the equivalent SNPN may be one or multiple PLMNs treated similarly to registered SNPNs.

Furthermore, the equivalent SNPN may be one or multiple SNPNs identified by the same PLMN ID(s) as those of any SNPN(s), or may be a PLMN(s). For example, the equivalent SNPN may be one or multiple SNPNs identified by the same PLMN ID(s) as those of the registered SNPN(s), or may be a PLMN(s). Furthermore, the equivalent SNPN may be a PLMN is identified by the same PLMN ID as that of the registered SNPN, and the equivalent PLMN of the PLMN.

1st identification information is information indicating whether the UE supports the extension of the LADN service area. The 1st identification information may be a bit indicating that the extension of the LADN service area is supported, or a bit indicating that the extension of the LADN service area is not supported.

The 1st identification information may be information indicating whether the UE supports the restriction on the use of extension of the LADN service area. Furthermore, the 1st identification information may be a bit indicating that the restriction on the use of extension of the LADN service area is supported, or a bit indicating that the restriction on the use of extension of the LADN service area is not supported.

Furthermore, the 1st identification information may be a bit constituting a 5GMM capability information element indicating capability of the UE in 5G. In addition, the 1st identification information may be information selected and determined based on capability information of the UE, and/or a configuration of the UE, and/or the state of the UE, and/or a user policy, and/or a request from an application.

2nd identification information is an LADN indication. The 2nd identification information is information indicating a request for LADN information. The 2nd identification information may be information indicating whether to request the LADN information. Furthermore, the 2nd identification information may be information indicating the requested LADN DNN.

Furthermore, the 2nd identification information may be information indicating the requested LADN serving area.

Furthermore, the 2nd identification information may be information indicating a request to update the LADN information, or may be information indicating updated LADN information. Furthermore, the 2nd identification information may be information indicating a request to delete the LADN information.

Furthermore, the 2nd identification information may be an information element including an LADN indication. Furthermore, the information element including the LADN indication may be an LADN indication information element. Note that the LADN indication information element may include one or multiple LADN DNNs. In contrast, the LADN indication information element may be an information element including no LADN DNN. In other words, the LADN indication information element may be an information element including no specific LADN DNN.

Furthermore, the 2nd identification information may be a bit constituting a 5G-MM capability information element indicating capability of the UE in 5G. Furthermore, the 2nd identification information may be information selected and determined based on capability information of the UE, and/or a configuration of the UE, and/or the state of the UE, and/or a user policy, and/or a request of an application.

11th identification information may be information indicating whether the network supports the extension of the LADN service area. The 11th identification information may be a bit indicating that the extension of the LADN service area is supported, or a bit indicating that the extension of the LADN service area is not supported.

The 11th identification information may be information indicating whether the network supports the restriction on the use of extension of the LADN service area. Furthermore, the 11th identification information may be a bit indicating that the restriction on the use of extension of the LADN service area is supported, or a bit indicating that the restriction on the use of extension of the LADN service area is not supported.

Furthermore, the 11th identification information may be a bit constituting a 5GS network feature support information element indicating capability of the network in 5G. Furthermore, the 11th identification information may be information selected and determined by the network, based on the 1st identification information received, and/or information associated with the DN, and/or information associated with the NSI, and/or capability information of the network, and/or an operator policy, and/or the state of the network, and/or registration information of a user, and/or the like. Furthermore, the 11th identification information may be information selected and determined based on any other identification information selected by the network in the present procedure.

12th identification information is LADN information. The 12th identification information may be LADN information allowed by the network, or valid LADN information. Furthermore, the 12th identification information may be information transmitted and/or received in a case that an LADN service area is present in the registration area to which the UE is connected.

Furthermore, in a case that the 1st identification information and/or the 11th identification information is information indicating that the extension of the LADN service area is supported, the 12th identification information may be extended LADN information different from the conventional LADN information. In contrast, in a case that the 1st identification information and/or the 11th identification information is information indicating that the extension of the LADN service area is not supported, the 12th identification information may be the conventional LADN information.

In a case that the 1st identification information and/or the 11th identification information are information indicating that the restriction on the use of extension of the LADN service area is supported, the 12th identification information may be the conventional LADN information. In contrast, in a case that the 1st identification information and/or the 11th identification information is information indicating that the restriction on the use of extension of the LADN service area is not supported, the 12th identification information may be extended LADN information different from the conventional LADN information.

Furthermore, the 12th identification information may be information selected and determined by the network, based on the identification information received, and/or the information associated with the DN, and/or information associated with the NSI, and/or the capability information of the network, and/or the operator policy, and/or the state of the network, and/or the registration information of the user and/or the like. Furthermore, the 12th identification information may be information selected and determined based on any other identification information selected by the network in the present procedure.

Furthermore, the 12th identification information may be an information element including LADN information. Furthermore, the information element including the LADN information may be an LADN information information element. Note that the LADN information information element may include one or multiple LADN DNNs. In contrast, the LADN information information element may be an information element including no an LADN DNN. In other words, the LADN information information element may be an information element including no specific LADN DNN.

13th identification information is information indicating the granularity of the LADN service area. The 13th identification information may be information indicating the size of the LADN service area. Furthermore, the 13th identification information may be transmitted and/or received in association with the 12th identification information, or may be transmitted and/or received in association with information included in the 12th identification information and that is present for each LADN (hereinafter referred to as the information indicating the LADN). Furthermore, the 13th identification information may be transmitted and/or received for each piece of information indicating the LADN. In this case, the 13th identification information may vary for each piece of information indicating the LADN, or may be the same among multiple pieces of information indicating multiple LADNs.

Note that, in a case that the 13th identification information is transmitted and/or received in association with the information indicating the LADN, the 13th identification information may he information indicating the granularity of the LADN service area information included in the information indicating the (hereinafter referred to as the LADN service area information).

For example, the 13th identification information may be information indicating that an area including one or multiple tracking areas is used as the LADN service area. In this case, the LADN service area information may be configured with a tracking area ID list including one or multiple tracking area IDs.

Furthermore, the 13th identification information may be information indicating that an area different from an area including one or multiple tracking areas is used as the LADN service area. In this case, the LADN service area information may be configured with information requiring the assistance of the RAN or information not requiring the assistance of the RAN.

Furthermore, the 13th identification information may be information indicating that an area covered by some base stations within the tracking area is used as the LADN service area. In this case, the LADN service area information may be configured with a cell ID and or a cell ID list including one and/or multiple cell IDs.

Furthermore, the 13th identification information may be information indicating that an area configured without depending on the tracking area is used as the LADN service area. In this case, the LADN service area information may be configured with physical location information, In this regard, in a case that the 13th identification information is not transmitted and/or received and/or that the 13th identification information is invalid information, an area including one or multiple tracking areas may be used as the LADN service area. Furthermore, the LADN service area information may be configured with a tracking area ID list including one or multiple tracking area IDs. Note that the granularity and/or the LADN service area information indicated by the 13th identification information need not be limited to the information described above.

Furthermore, the 13th identification information may be information selected and determined by the network, based on the 1st identification information received, and/or information associated with the and/or information associated with the NSI, and/or the capability information of the network, and/or the operator policy, and/or the state of the network, and/or the registration information of a user, and/or the like. Furthermore, the 13th identification information may be information selected and determined, based on any other identification information selected by the network in the present procedure.

14th identification information is information indicating a duration in which the LADN service area is valid. The 14th identification information may be information indicating whether the LADN service area is currently valid. Furthermore, the 14th identification information may be transmitted and/or received in association with the 12th identification information, or may be transmitted and/or received in association with information included in the 12th identification information and that is present for each LADN (hereinafter referred to as the information indicating the LADN). Furthermore, the 14th identification information may be transmitted and/or received for each piece of information indicating the LADN. In this case, the 14th identification information may be different for each piece of information indicating the LADN, or may be the same among multiple pieces of information indicating LADNs.

In this regard, the information indicating the duration in which the LADN service area is valid may be information indicating the time for which the LADN service area is valid, or information indicating a duration indicated by concrete date and time. Furthermore, the information indicating the duration in which the LADN service area is valid may be information indicating a specific time period, or information indicating specific days of the week. Furthermore, the information indicating the duration in which the LADN service area is valid may be information indicating a specific day, or information indicating a specific week. Furthermore, the information indicating the duration in which the LADN service area is valid may be information indicating a specific month, or information indicating a specific year.

In this regard, in a case that the 14th identification information is not transmitted and/or received and/or that the 14th identification information is invalid information, the duration in which the LADN service area is valid may be the time until the LADN information and/or the information indicating the is updated. Note that the information indicating the duration in which the LADN service area is valid is not limited to the information described above.

Furthermore, the 14th identification information may be information selected and determined by the network, based on the 1st identification information received, and/or information associated with the DN, and/or information associated with the NSI, and/or the capability information of the network, and/or the operator policy, and/or the state of the network, and/or the registration information of the user, and/or the like. Furthermore, the 14th identification information may be information selected and determined based on any other identification information selected by the network in the present procedure.

15th identification information is an LADN failure indication. The 15th identification information may be information indicating that a request for the LADN information for the LADN DNN included in the LADN indication information element has failed. In other words, the 15th identification information may be information indicating that a request for the LADN information for one or multiple of the LADN DNNs included in the 2nd identification information has failed.

Furthermore, the 15th identification information may be information indicating the LADN DNN for which the request for the LADN information has failed. In other words, the 15th identification information may be information indicating those of the LADN DNNs included in the 12th identification information for which the request for the LADN information has failed.

Furthermore, the 15th identification information may be information including one or multiple LADN DNNs.

Moreover, the 15th identification information may be an information element including an LADN failure indication. Furthermore, the information element including the LADN failure indication may be an LADN failure indication information element. Note that the LADN failure indication information element may include one or multiple LADN DNNs.

Furthermore, the 15th identification information may be information selected and determined by the network, based on the 2nd identification information received and a DNN list held by the network. In this regard, the DNN list held by the network may be a list of DNNs associated with the subscriber information of the UE.

Specifically, in a case that one or multiple of the LADN DNNs included in the 2nd identification information match none of the DNNs included in the DNN list held by the network, the network may include the LADN DNNs in the 15th identification information. In other words, in a case that one or multiple LADN DNNs are present that are included in the 2nd identification information and further that match none of the DNNs included in the DNN list held by the network, the network may include the one or more LADN DNNs in the 15th identification information.

Furthermore, the 15th identification information may be information selected and determined by the network, based on the 2nd identification information received and the LADN DNNs configured by the network.

Specifically, in a case that one or multiple of the LADN DNNs included in the 2nd identification information match none of the DNNs included in the LADN DNN configured for the network, the network may include one or more the LADN DNNs in the 15th identification information. In other words, in a case that one or multiple LADN DNNs are present that are included in the 2nd identification information and further that match none of the LADN DNNs configured for the network, the network may include the one or more LAN DNNs in the 15th identification information.

Furthermore, the 15th identification information may be information selected and determined by the network, based on the 2nd identification information received, and/or information associated with the DN, and/or information associated with the NSI, and/or the capability information of the network, and/or the operator policy, and/or the state of the network, and/or the registration information of the user, and/or the like. Furthermore, the 15th identification information may be information selected and determined based on any other identification information selected by the network in the present procedure.

26th identification information is information indicating the DNN. The 26th identification information may be information indicating the DNN requested by the UE. More specifically, the 26th identification information may be information indicating the DNN that is requested by the UE and associated with a PDU session established in the present procedure. Furthermore, the 26th identification information may be information selected and determined based on one or more of the 11th identification information to the 17th identification information that is transmitted and/or received, and/or a configuration of the UE, and/or the state of the UE, and/or a user policy, and/or a request from an application.

36th identification information is information indicating the DNN. The 36th identification information may be information indicating the DNN selected by the network. More specifically, the 36th identification information may be information indicating the DNN that is selected by the network and associated with a PDU session established in the present procedure.

Furthermore, the 36th identification information may be information selected and determined by the network, based on the 36th identification information received, and/or information associated with the NSI, and/or the capability information of the network, and/or the operator policy, and/or the state of the network, and/or the registration information of the user, and/or the like. Furthermore, the 36th identification information may be information selected and determined based on any other identification information selected by the network in the present procedure.

41st identification information is a cause value indicating the cause of disallowance of a request from the UE. The 41st identification information may be a 5GS Session Management (5GSM) cause value. Furthermore, the 41st identification information may be information indicating that the UE is located outside the LADN service area. Furthermore, the 41st identification information may be information used by the network to indicate that the UE is located outside the LADN service area.

Moreover, the 41st identification information the 41st identification information may be information indicating that a requested LADN is not allowed in the area to which the UE currently belongs. Note that the area to which the UE currently belongs may be an area including one or multiple tracking areas, or may be an LADN service area associated with the LADN DNN.

Furthermore, the 41st identification information may be information selected and determined by the network, based on the identification information received by the UE, and/or the capability information of the network, and/or the operator policy, and/or the state of the network, and/or the registration information of the user, and/or the area to which the UE currently belongs, and/or the like.

Furthermore, the 41st identification information may be the 46th 5GSM cause value indicating out-of-LADN-service. In other words, the 41st identification information may be 5GSM cause #46 “out of LADN service area.” Note that the 5GSM cause #46 “out of LADN service area” may be a cause value indicating that the UE is located outside the LADN service.

Furthermore, the 41st identification information may be a 5GS Mobility Management (5GMM) cause value. Furthermore, the 41st identification information may be information used in a case that the AMF fails to transfer, to the SMF, an SM message such as a PDU session establishment request message which is received from the UE.

### 3.2. Description of Procedures Used in Each Embodiment

Next, procedures used in each embodiment will be described. Note that the procedures used in each embodiment include a Registration procedure, a PDU session establishment procedure, and a UE configuration update procedure (Generic UE configuration update procedure). Each procedure will be described below.

Note that, in each embodiment, a case that each of the combinations including the HSS and the UDM, the PCF and the PCRF, the SMF and the PGW-C, and the UPF and the PGW-U is configured to form a single apparatus (that is, the same physical hardware, or the same logical hardware, or the same software) as illustrated in FIG. 2 will be described as an example. However, the details described in the present embodiment can also be applied to a case that each of the combinations is configured to form different apparatuses (that is, different pieces of physical hardware, or different pieces of logical hardware, or different pieces of software). For example, data may be directly transmitted and/or received between these apparatuses, data may be transmitted and/or received over the N26 interface between the AMF and the MME, or data may be transmitted and/or received via the UE.

### 3.2.1. Registration Procedure

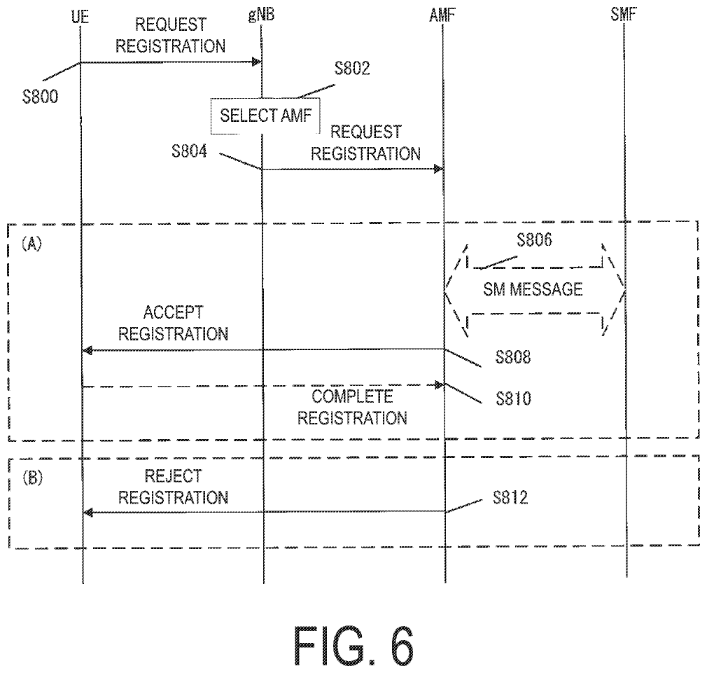

First, the Registration procedure will be described with reference to FIG. 6. The registration procedure is a procedure in the 5GS. Hereinafter, the present procedure will refer to the registration procedure. The registration procedure is a procedure for registration with the access network_B, and/or the core network_B, and/or the DN as initiated by the UE. In a case that the UE is in a state of not being registered with the network, for example, the can perform the present procedure at any timing such as the timing at which the UE is turned on. In other words, the UE can initiate the present procedure at any timing in a case that the UE is in the deregistered state (RM-DEREGISTERED state). Each apparatus (in particular, the UE and the AMF) can transition to the registered state (RM-REGISTERED state), based on completion of the registration procedure.

In addition, the registration procedure may be a procedure for updating position registration information of the UE in the network, and/or periodically giving a notification of the state of the UE from the UE to the network, and/or updating a specific parameter related to the UE in the network.

In a case that the UE performs mobility for crossing a TA, the UE may initiate the registration procedure. In other words, in a case that the UE moves to a TA that is different from the TA indicated in the stored TA list, the UE may initiate the registration procedure. In addition, the UE may initiate the present procedure in a case that a running timer expires. In addition, the UE may initiate the registration procedure in a case that a context of each apparatus needs to be updated due to disconnection and deactivation of a PDU session. In addition, in a case that there is a change in capability information and/or a preference, related to PDU session establishment, of the UE, the UE may initiate the registration procedure. In addition, the UE may periodically initiate the registration procedure. Furthermore, the UE may initiate the registration procedure based on completion of the UE configuration update procedure. Note that these are not restrictive, and the UE can perform the registration procedure at any timing.

Furthermore, even in the registered state, the UE may periodically initiate the registration procedure. In other words, the UE may initiate the registration procedure based on the expiration of the timer. Moreover, the UE may periodically initiate the registration procedure in a state of storing the LADN information in the UE. Furthermore, the UE may initiate the registration procedure in a state in which a PDU session is established. Note that the PDU session may be a PDU session associated with the LADN information, or a PDU session for the LADN. Furthermore, the PDU session may be a PDU session associated with the NSSAI.

Note that a registration procedure performed based on the mobility of the UE and a periodically performed registration procedure may be expressed as a registration procedure for mobility and registration update. In other words, the registration procedure for mobility and registration update may be a registration procedure performed based on the mobility of the UE or a periodically performed registration procedure. Furthermore, the registration procedure for mobility and registration update may be a registration procedure performed based on the configuring update of the UE. Furthermore, the registration procedure for mobility and registration update may be a registration procedure performed to establish a communication path through which user data is transmitted and/or received. Furthermore, the registration procedure for mobility and registration update may be a registration procedure performed based on a request from the network. In other words, the registration procedure for mobility and registration update may be a registration procedure other than an initial registration procedure. Hereinafter, the registration procedure for mobility and registration update may be expressed as the present procedure.

Now, each step of the registration procedure will be described. Note that the registration procedure described below may be an initial registration procedure, or a registration procedure for mobility and registration update.

First, the UE transmits a Registration request message to the AMF (S800), (S802), and (S804) to initiate the registration procedure. Specifically, the UE transmits an RRC message including the registration request message to the 5G AN (or the gNB) (S800). Note that the registration request message is a NAS message. The RRC message may be a control message transmitted and/or received between the UE and the 5G AN (or the gNB). The NAS message is processed in the NAS layer, and the RRC message is processed in the RRC layer. Note that the NAS layer is a layer higher than the RRC layer.

In this regard, the UE can include, in a registration request message and/or an RRC message, one or more of at least the 1st identification information and the 2nd identification information and transmit the registration request message and/or the RRC message. However, the UE may include the identification information in a control message different from the registration request message and/or the RRC message, for example, a control message in a layer lower than the RRC layer (for example, the MAC layer, RLC layer, or PDCP layer) and transmit the control message. Note that, by transmitting these pieces of identification information, the UE may indicate that the UE supports each function, or may indicate a request of the UE.

Furthermore, in a case that multiple pieces of identification information are transmitted and/or received, two or more pieces of the identification information may be configured as one or more pieces of the identification information. Note that information indicating support of each function and information indicating a request for use of each function may be transmitted and/or received as the same piece of identification information, or may be transmitted and/or received as different pieces of identification information.

In a case that the UE supports the extension of the LADN service area, the UE may configure, in the 1st identification information, information indicating that the UE supports the extension of the LADN service area, or may include, in the registration request message, the 1st identification information indicating that the UE supports the extension of the LADN service area and transmit the registration request message. In contrast, in a case that the UE does not support the extension of the LADN service area, the UE may configure, in the 1st identification information, information indicating that the UE does not support the extension of the LADN service area, or may include, in the registration request message, the 1st identification information indicating that the UE does not support the extension of the LADN service area and transmit the registration request message, or need not transmit the 1st identification information.

In a case that the UE supports the restriction on the use of extension of the LADN service area, the UE may configure, in the 1st identification information, information indicating that the UE supports the restriction on the use of extension of the LADN service area, or may include, in the registration request message, the 1st identification information indicating that the UE supports the restriction on the use of extension of the LADN service area, and transmit the registration request message. In contrast, in a case that the UE does not support the restriction on the use of extension of the LADN service area, the UE may configure, in the 1st identification information, information indicating that the UE does not support the restriction on the use of extension of the LADN service area, or may include, in the registration request message, the 1st identification information indicating that the UE does not support the restriction on the use of extension of the LADN service area and transmit the registration request message, or need not transmit the 1st identification information.

Furthermore, the UE may indicate that the UE supports the extension of the LADN service area by transmitting the 1st identification information. In this case, the 1st identification information may be information indicating that the extension of the LADN service area is supported.

In contrast, the UE may indicate that the UE supports the restriction on the use of extension of the LADN service area by transmitting the 1st identification information. In this case, the 1st identification information may be information indicating that the restriction on the use of extension of the LADN service area is supported.

By including and transmitting an SM message (for example, the PDU session establishment request message) in the registration request message, or by transmitting an SM message (for example, the PDU session establishment request message) together with the registration request message, the UE may initiate the PDU session establishment procedure during the registration procedure.

After the 5G AN (or the gNB) receives the RRC message including the registration request message, the 5G AN (or the gNB) selects the AMF to which the registration request message is to be transferred (S802). Note that the 5G AN (or the gNB) can select the AMF, based on information included in the registration request message and/or the RRC message. The 5G AN (or the gNB) extracts the registration request message from the received RRC message, and transfers the registration request message to the selected AMF (S804).

In a case that the AMF receives the registration request message, the AMF can perform the 1st condition fulfillment determination. The 1st condition fulfillment determination is a condition fulfillment determination for determining whether or not the network (or the AMF) accepts the request from the UE. In a case that the 1st condition fulfillment determination is true, the AMF initiates the procedure of (A) of FIG. 6, whereas in a case that the 1st condition fulfillment determination is false, the AMF initiates the procedure of (B) of FIG. 6.

Note that the first condition fulfillment determination may be performed based on the reception of the registration request message, and/or each piece of identification information included in the registration request message, and/or the subscriber information, and/or the capability information of the network, and/or the operator policy, and/or the state of the network, and/or the registration information of the user, and/or a context held by the AMF, and/or the like. For example, the first condition fulfillment determination may be true in a case that the network allows the request from the UE, and the first condition fulfillment determination may be false in a case that the network does not allow the request from the UE. In a case that a network with which the UE is to be registered and/or an apparatus in the network supports the function requested by the UE, the 1st condition fulfillment determination may be true, whereas in a case that the network and/or the apparatus does not support the function requested by the UE, the 1st condition fulfillment determination may be false. In addition, in a case that the transmitted and/or received identification information is allowed, the 1st condition fulfillment determination may be true, whereas in a case that the transmitted and/or received identification information is not allowed, the 1st condition fulfillment determination may be false. Note that the conditions on which true or false of the 1st condition fulfillment determination is determined need not be limited to the conditions described above.

First, a case that the 1st condition fulfillment determination is true will be described. In the procedure of (A) of FIG. 6, first, the AMF can perform the 4th condition fulfillment determination. The 4th condition fulfillment determination is a condition fulfillment determination for determining whether or not the AMF performs transmission and/or reception of an SM message to and/or from the SMF.

Note that the 4th condition fulfillment determination may be performed based on whether or not the AMF has received an SM message. The 4th condition fulfillment determination may be performed based on whether the registration request message includes an SM message. For example, in a case that the AMF receives an SM message, and/or a case that the registration request message includes an SM message, the 4th condition fulfillment determination may be true, whereas in a case that the AMF does not receive an SM message, and/or a case that the registration request message does not include an SM message, the 4th condition fulfillment determination may be false. Note that the conditions on which true or false of the 4th condition fulfillment determination is determined need not be limited to the conditions described above.

In a case that the 4th condition fulfillment determination is true, the AMF selects the SMF, and performs transmission and/or reception of an SM message to and/or from the selected SMF. whereas in a case that the 4th condition fulfillment determination is false, the AMF does not perform the transmission and/or reception (S806). Even in a case that the 4th condition fulfillment determination is true, the AMF may cancel the procedure of (A) of FIG. 6 in a case that the AMF receives an SM message indicating rejection from the SMF. In this case, the AMF can initiate the procedure of (B) of FIG. 6.

Note that, in a case that the AMF performs transmission and/or reception of an SM message to and/or from the SMF in S806, the AMF can notify the SMF of the identification information received in the registration request message. The SMF transmits and/or receives an SM message to and/or from the AMF, and can thereby acquire the identification information received from the AMF.

Next, the AMF transmits a REGISTRATION ACCEPT message to the UE via the 5G AN (or the gNB) as a response message to the registration request message, based on reception of the registration request message, and/or completion of transmission and/or reception of the SM message to and/or from the SMF (S808). For example, in a case that the 4th condition fulfillment determination is false, the AMF may transmit the REGISTRATION ACCEPT message, based on the reception of the registration request message from the UE. In a case that the 4th condition fulfillment determination is true, the AMF may transmit the REGISTRATION ACCEPT message, based on completion of transmission and/or reception of the SM message to and/or from the SMF. Note that the REGISTRATION ACCEPT message is a NAS message transmitted and/or received on the N1 interface; however, between the UE and the 5G AN (gNB), the REGISTRATION ACCEPT message is transmitted and/or received on an RRC message.

The AMF may include, in the REGISTRATION ACCEPT message, one or more pieces of at least the 11th identification information to the 15th identification information, and transmit the REGISTRATION ACCEPT message. Note that, by transmitting these pieces of identification information, the AMF may indicate that the network supports each function, or may indicate that the request from the UE is accepted. Furthermore, in a case that multiple pieces of identification information are transmitted and/or received, two or more of the identification information may be configured as one or more pieces of the identification information. Note that information indicating support of each function and information indicating a request for use of each function may be transmitted and/or received as the same piece of identification information, or may be transmitted and/or received as different pieces of identification information.

In a case that the AMF supports the extension of the LADN service area, the AMF may configure, in the 11th identification information, the information indicating that the AMF supports the extension of the LADN service area, or may include, in the REGISTRATION ACCEPT message, the 11th identification information indicating that the AMF supports the extension of the LADN service area and transmit the REGISTRATION ACCEPT message. In contrast, in a case that the AMF does not support the extension of the LADN service area, the AMF may configure, in the 11th identification information, the information indicating that the AMF does not support the extension of the LADN service area, or may include, in the REGISTRATION ACCEPT message, the 11th identification information indicating that the AMF does not support the extension of the LADN service area and transmit the REGISTRATION ACCEPT message, or need not transmit the 11th identification information.

In a case that the AMF supports the restriction on the use of extension of the LADN service area, the AMF may configure, in the 11th identification information, the information indicating that the AMF supports the restriction on the use of extension of the LADN service area, or may include, in the REGISTRATION ACCEPT message, the 11th identification information indicating that the AMF supports the restriction on the use of extension of the LADN service area and transmit the REGISTRATION ACCEPT message. In contrast, in a case that the AMF does not support the restriction on the use of the extension of the LADN service area, the AMF may configure, in the 11th identification information, the information indicating that the AMF does not support the restriction on the use of extension of the LADN service area, or may include, in the REGISTRATION ACCEPT message, the 11th identification information indicating that the AMF does not support the restriction on the use of extension of the LADN service area and transmit the REGISTRATION ACCEPT message, or need not transmit the 11th identification information.

Furthermore, the AMF max indicate that the network supports the extension of the LADN service area by transmitting the 11th identification information. Furthermore, by transmitting the 11th identification information, the AMF may indicate that the extension of the LADN service area is available. Moreover, by transmitting the 11th identification information, the AMF may indicate that the network allows the use of extension of the LADN service area. In this case, the 11th identification information may be information indicating that the extension of the LADN service area is supported.

In contrast, the AMF may indicate that the network does not support the extension of the LADN service area by transmitting the 11th identification information indicating that the AMF does not support the extension of the LADN service area, or by not transmitting the 11th identification information. Furthermore, the AMF may indicate that the extension of the LADN service area is not available by transmitting the 11th identification information indicating that the AMF does not support the extension of the LADN service area, or by not transmitting the 11th identification information. Furthermore, the AMF may indicate that the network does not allow the use of extension of the LADN service area by transmitting the 11th identification information indicating that the AMF does not support the extension of the LADN service area or by not transmitting the 11th identification information.

Furthermore, by transmitting the 11th identification information, the AMF may indicate that the network supports the restriction on the use of extension of the LADN service area. Furthermore, by transmitting the 11th identification information, the AMF may indicate that the use of extension of the LADN service area is restricted. In this case, the 11th identification information may be information indicating that the restriction on the use of extension of the LADN service area is supported.

In contrast, the AMF may indicate that the network does not support the restriction on the use of extension of the LADN service area by transmitting the 11th identification information indicating not supporting the restriction on the use of the extension of the LADN service area, or by not transmitting the 11th identification information. Furthermore, the AMF may indicate that the use of extension of the LADN service area is not restricted, by transmitting the 11th identification information indicating that the AMF does not support the restriction on the use of extension of the LADN service area, or by not transmitting the 11th identification information.

In this regard, the AMF may transmit the 11th identification information based on the 1st identification information. Specifically, in a case that the 1st identification information is information indicating that the extension of the LADN service area is supported, the AMF may transmit, to the UE, the 11th identification information indicating that the AMF supports the extension of the LADN service area. In contrast, in a case that the 1st identification information is information indicating that the extension of the LADN service area is not supported, the AMF may transmit, to the UE, the 11th identification information indicating that the AMF does not support the extension of the LADN service area.

Furthermore, in a case that the 1st identification information is information indicating that the restriction on the use of extension of the LADN service area is supported and that the AMF determines to restrict the use of extension of the LADN service area, the AMF may configure, in the 11th identification information, the information indicating the restriction on the use of extension of the LADN service area, or may transmit, to the UE, the 11th identification information indicating the restriction on the use of extension of the LADN service area. In contrast, in a case that the 1st identification information is information indicating that the AMF does not support the extension of the LADN service area, the AMF need not transmit the 11th identification information.

Furthermore, by transmitting the 12th identification information, the AMF may indicate that the network supports the LADN, or indicate that connection to the LADN is allowed. Furthermore, by transmitting the 12th identification information, the AMF may notify the UE of a list of DNNs available for connection to the LADN, and/or of the LADN service area, corresponding to an area where connection to the LADN is enabled. Moreover, by transmitting the 12th identification information, the AMF may notify the UE of one or multiple S-NSSAIs available for connection to LADN. Note that the S-NSSAIs available for connection to the LADN, the DNNs available for connection to the LADN, and/or the LADN service area may be associated with one another.

In this regard, the AMF may transmit the 12th identification information based on the 1st identification information. Specifically, in a case that the 1st identification information is information indicating that the extension of the LADN service area is supported, the AMF may configure an extended LADN service area as the LADN service area, or configure extended LADN information as the LADN information, and may transmit the configured LADN information to the UE as the 12th identification information. In contrast, in a case that the 1st identification information is information indicating that the extension of the LADN service area is not supported, the AMF may configure the conventional LADN service area as the LADN service area, or configure the conventional LADN information as the LADN information, and may transmit the configured LADN information to the UE as the 12th identification information.

In contrast, by not transmitting the 12th identification information, the AMF may indicate that the network does not support the LADN or that the network does not allow connection to the LADN. Furthermore, by not transmitting the 12th identification information, the AMF may indicate that the LADN information stored in the UE is invalid or may indicate to the UE invalidation of the LADN information stored in the UE. Furthermore, by not transmitting the 12th identification information, the AMF may indicate that the LADN information stored by the UE needs to be deleted or may indicate to the UE deletion of the LADN information stored by the UE.

Moreover, by transmitting the 12th identification information that is blank, the AMF may indicate that the network does not support the LADN or that the network does not allow connection to the LADN. Furthermore, by transmitting the 12th identification information that is blank, the AMF may indicate that the LADN information stored by the UE is invalid or may indicate to the UE invalidation of the LADN information stored by the UE. Furthermore, by transmitting the 12th identification information that is blank, the AMF may indicate that the LADN information stored by the UE needs to be deleted or may indicate to the UE deletion of the LADN information stored by the UE.

In this regard, the AMF may transmit the 12th identification information based on the 2nd identification information. Specifically, in a case that the 2nd identification information indicates a request for the LADN information, the AMF may include the 12th identification information in the REGISTRATION ACCEPT message, or may transmit the 12th identification information to the UE. Furthermore, also in a case that the 2nd identification information indicates a request to update the LADN information, the AMF may include the 12th identification information in the REGISTRATION ACCEPT message, or may transmit the 12th identification information to the UE. In contrast, in a case that the 2nd identification information indicates a request to delete the LADN information, the AMF need not include the 12th identification information in the REGISTRATION ACCEPT message, or need not transmit the 12th identification information to the UE. Furthermore, in a case that the 2nd identification information indicates a request to delete the LADN information, the AMF may include, in the REGISTRATION ACCEPT message, the 12th identification information that is blank, or may transmit, to the UE, the 12th identification information that is blank.

Furthermore, in a case that the AMF desires to invalidate the LADN information stored by the UE, the AMF need not include the 12th identification information in the REGISTRATION ACCEPT message, or need not transmit the 12th identification information to the UE. Furthermore, in a case that the AMF desires to invalidate the LADN information stored by the UE, the AMF may include, in the registration accept message, the 12th identification information that is blank, or may transmit, to the UE, the 12th identification information that is blank. Furthermore, in a case that the AMF desires to delete the LADN information stored by the UE, the AMF need not include the 12th identification information in the REGISTRATION ACCEPT message, or need not transmit the 12th identification information to the UE. Moreover, in a case that the AMF desires to delete the LADN information stored by the UE, the AMF may include, in the REGISTRATION ACCEPT message, the 12th identification information that is blank, or may transmit, to the UE, the 12th identification information that is blank.

Furthermore, in a case that the AMF does not include the 12th identification information in the REGISTRATION ACCEPT message during the registration procedure for mobility and registration update, the AMF may recognize old LADN information as invalid, or delete the old LADN information. In this case, in a case that a PDU session for the LADN is established, the AMF may locally release the PDU session for the or may request the SMF to locally release the PM session for the LADN.

More specifically, in a case that the AMF does not include the 12th identification information in the REGISTRATION ACCEPT message during the registration procedure for mobility and registration update, the AMF may recognize the old LADN information as invalid, or delete the old LADN information. In this case, in a case that PDU sessions for one or multiple LADNs are established, the AMF may locally release the PDU sessions for all the LADNs, or may request the SMF to locally release the PDU sessions for all the LADNs.

Furthermore, in a case that the AMF does not include the 12th identification information in the REGISTRATION ACCEPT message during the registration procedure for mobility and registration update, the AMF may recognize the old LADN information as invalid, or delete the old LADN information. In this case, in a case that a PDU session for the LADN is established, the AMF may request the SMF to release the PDU session for the LADN. In this case, the SMF may initiate a network request PDU session release procedure.

More specifically, in a case that the AMF does not include the 12th identification information in the REGISTRATION ACCEPT message during the registration procedure for mobility and registration update, the AVIF may recognize the old LADN information as invalid, or delete the old LADN information. In this case, in a case that PDU sessions for one or multiple LADNs are established, the AMF may request the SMF to release of the PDU sessions for all the LADNs. In this case, the SMF may initiate the network request PDU session release procedure.

Furthermore, in a case that the LADN information associated with the PDU session for the LADN is not included in the REGISTRATION ACCEPT message, the AMF may recognize the old LADN information as invalid, or delete the old LADN information. In this case, the AMF may locally release the PDU session for the LADN, or may request the SMF to locally release the PDU session for the LADN.

Furthermore, in a case that the LADN information associated with the PDU session for the LADN is not included in the REGISTRATION ACCEPT message, the AMF may recognize the old LADN information as invalid, or delete the old LADN information. In this case, the AMF may request the SMF to release the PDU session for the LADN.

Furthermore, in a case that the LADN information associated with the PDU session for the LADN is not included in the REGISTRATION ACCEPT message, the AMF may recognize the old LADN information as invalid, or delete the old LADN information. In this case, the AMF may request the SMF to release the PDU session for the LADN. In this case, the SMF may initiate the network request PDU session release procedure,

Furthermore, in a case that the LADN information associated with the PDU session for the LADN is not included in the REGISTRATION ACCEPT message, the AMF may recognize the old LADN information as invalid, or delete the old LADN information. In this case, the AMF may request the SMF to release the PDU session for the LADN. In this case, the SMF may initiate the network request PDU session release procedure.

Furthermore, the AMF may indicate the granularity of the LADN service area by transmitting the 13th identification information. More specifically, by transmitting the 13th identification information together with the 12th identification information, the AMF may indicate the granularity of the LADN service area indicated by the LADN service area information included in the LADN information indicated by the 12th identification information, or may notify an area that can be used as the LADN service area. Specifically, by transmitting the 13th identification information together with the 12th identification information, the AMF may indicate that the LADN service area indicated by the LADN service area information included in the 12th identification information is an area including one or multiple tracking areas, or may indicate that the area differs from an area including one or multiple tracking areas. Furthermore, by transmitting the 13th identification information together with the 12th identification information, the AMF may indicate that a tracking area ID list is included as the LADN service area information, or that information requiring the assistance of the RAN is included as the LADN service area information, or that information not requiting the assistance of the RAN is included as the LADN service area information.

In this regard, the AMF may determine whether to transmit the 13th identification information based on the 1st identification information. Specifically, in a case that the 1st identification information is information indicating that the extension of the LADN service area is supported, the AMF may transmit the 13th identification information to the UE In contrast, in a case that the 1st identification information is information indicating that the extension of the LADN service area is not supported, the AMF need not transmit the 13th identification information to the UE.

Furthermore, the AMF may indicate the duration in which the LADN service area is valid by transmitting the 14th identification information, More specifically, by transmitting the 14th identification information together with the 12th identification information, the AMF may indicate the duration in which the LADN service area is valid that is indicated by the LADN service area information included in the LADN information indicated by the 12th identification information.

In this regard, the AMF may determine whether to transmit the 14th identification information based on the 1st identification information. Specifically, in a case that the 1st identification information is information indicating that the extension of the LADN service area is supported, the AMF may transmit the 14th identification information to the UE. In contrast, in a case that the 1st identification information is information indicating that the extension of the LADN service area is not supported. the AMF need not transmit the 14th identification information to the UE.

Furthermore, by transmitting, together with the 12th identification information, the 11th identification information, and/or the 13th identification information, and/or the 14th identification information, the AMF may indicate that extended LADN information and/or an extended LADN service area is available, or notify of the LADN information and/or LADN service area information available, In this case, the 11th identification information may be information indicating that the extension of the LADN service area is supported, and the 12th identification information may be the extended LADN information.

In contrast, by transmitting the 11th identification information and/or the 12th identification information, while not transmitting the 13th identification information and/or the 14th identification information, the AMF may indicate that no extended LADN information and/or extended LADN service area is available. In other words, by transmitting the 11th identification information and/or the 12th identification information, while not transmitting the 13th identification information and/or the 14th identification information, the AMF may indicate: that the conventional LADN information and/or the conventional LADN service area is available, or may notify of the LADN information and/or LADN service area information available. In this case, the 11th identification information may be information indicating that the extension of the LADN service area is not supported, and the 12th identification information may be the conventional LADN information.

Furthermore, by transmitting the 12th identification information, while not transmitting the 11th identification information, and/or the 13th identification information, and/or the 14th identification information, the AMF may indicate that no extended LADN information and/or extended LADN service area is available. In other words, by transmitting the 12th identification information, while not transmitting the 11th identification information, and/or the 13th identification information and/or the 14th identification information, the AMF may indicate that the conventional LADN information and/or the conventional LADN service area is available, or may notify of the LADN information and/or LADN service area information available. In this case, the 12th identification information may be the conventional LADN information.

Furthermore, based on the reception of the 2nd identification information and/or the DNN list held by the AMF, the AMF may determine whether to include the 12th identification information in the registration procedure message, or may determine which LADN DNN is to be included in the 12th identification information. Furthermore, the AMF may include, in the 12th identification information, an LADN DNN selected and/or determined. In contrast, the AMF need not include, in the 12th identification information, LADN DNNs not selected and/or determined. In this regard, the DNN list held by the AMF may be a list of DNNs associated with the subscriber information of the UE.

Specifically, in a case that one or multiple of the LADN DNNs included in the 2nd identification information match none of the DNNs included in the DNN list held by the AMF, the AMF need not include the LADN DNNs in the 12th identification information. In other words, in a case that one or multiple LADN DNNs are present that are included in the 2nd identification information and further that match none of the DNNs included in the DNN list held by the AMF, the AMF need not include the LADN DNNs in the 12th identification information.

In contrast, even in a case that one or multiple of the LADN DNNs included in the 2nd identification information match none of the DNNs included in the DNN list held by the AMF, the AMF may include the one or multiple LAM DNNs LADN DNNs in the 12th identification information. In other words, even in a case that one or multiple LADN DNNs are present that are included in the 2nd identification information and further that match none of the DNNs included in the DNN list held by the AMF, the AMF may include the one or multiple LADN DNNs LADN DNNs in the 12th identification information. In this regard, the LADN DNNs included in the 12th identification information may be LADN DNNs included in the DNN list held by the AMF, or may be default LADN DNNs. Note that the LADN DNNs included in the 12th identification information are not limited to those described above and that any LADN DNNs may be included.

Furthermore, based on the reception of the 2nd identification information and/or the LADN DNN configured for the AMF, the AMF may determine whether to include the 12th identification information in the registration procedure message or may determine which LADN DNN is to be included in the 12th identification information. Furthermore, the AMF may include, in the 12th identification information, an LADN DNN selected and/or determined. In contrast, the AMF need not include, in the 12th identification information, DNNs not selected and/or determined.

Specifically, in a case that one or multiple of the LADN DNNs included in the 2nd identification information match none of the LADN DNNs configured for the AMF, the AMF need not include the LADN DNNs in the 12th identification information. In other words, in a case that one or multiple LADN DNNs are present that are included in the 2nd identification information and further that match none of the LADN DNNs configured for the AMF, the AMF need not include the LADN DNNs in the 12th identification information.

In contrast, even in a case that one or multiple of the LADN DNNs included in the 2nd identification information match none of the LADN DNNs configured for the AMF, the AMF may include the one or multiple LADN DNNs LADN DNNs in the 12th identification information. In other words, even in a case that one or multiple LADN DNNs are present that are included in the 2nd identification information and further that match none of the LADN DNNs configured for the AMF, the AMF may include the one or multiple LADN DNNs LADN DNNs in the 12th identification information. In this regard, the LADN DNNs included in the 12th identification information may be LADN DNNs configured for the AMF, or may be default LADN DNNs. Note that the LADN DNNs included in the 12th identification information are not limited to those described above and that any LADN DNNs may be included,

Furthermore, by transmitting the 12th identification information not including one or multiple of the LADN DNNs, the AMF may indicate that a request for LADN information for the LADN DNNs not included in the 12th identification information has failed. Furthermore, by transmitting the 12th identification information not including one or multiple of the LADN DNNs, the AMF may indicate that a registration procedure for requesting new LADN information for the LADN DNNs not included in the 12th identification information is prohibited from being re-performed. In this regard, the LADN DNNs not included in the 12th identification information may be one or multiple of the LADN DNNs included in the 2nd identification information.

In other words, in a case that one or multiple LADN DNNs are present that are included in the 2nd identification information and further that are not included in the 12th identification information, the AMF may indicate that the request for LADN information for the LADN DNNs has failed. Furthermore, in other words, in a case that one or multiple LADN DNNs are present that are included in the 2nd identification information and further that are not included in the 12th identification information, the AMF may indicate that the registration procedure for requesting new LADN information for the LADN DNNs is prohibited from being re-performed.

Furthermore, the AMF may determine whether to include the 15th identification information in the registration procedure message based on the reception of the 2nd identification information and/or the DNN list held by the AMF, or may determine which LADN DNN is to be included in the 15th identification information. In this regard, the DNN list held by the AMF may be a list of DNNs associated with the subscriber information of the UE.

Specifically, in a case that one or multiple of the LADN DNNs included in the 2nd identification information match none of the DNNs included in the DNN list held by the AMF, the AMF may include the LADN DNNs in the 15th identification information. In other words, in a case that one or multiple LADN DNNs are present that are included in the 2nd identification information and further that match none of the DNNs included in the DNN list held by the AMF, the AMF may include the LADN DNNs in the 15th identification information.

Furthermore, based on the reception of the 2nd identification information and/or the LADN DNN configured for the AMF, the AMF may determine whether to include the 15th identification information in the registration procedure message, or may determine which LADN DNN is to be included in the 15th identification information.

Specifically, in a case that one or multiple of the LADN DNNs included in the 2nd identification information match none of the LADN DNNs configured for the AMF, the AMF may include the LADN DNNs in the 15th identification information. In other words, in a case that one or multiple LADN DNNs are present that are included in the 2nd identification information and further that match none of the LADN DNNs configured for the AMF, the AMF may include the LAM DNNs in the 15th identification information.

Furthermore, by transmitting the 15th identification information, the AMF may indicate that the request for LADN information for the LADN DNNs included in the 15th identification information has failed. Furthermore, by transmitting the 15th identification information, the AMF may indicate that the registration procedure for requesting new LADN information for the LADN DNNs included in the 15th identification information is prohibited from being re-performed.

Furthermore, even in a case that one or multiple LADN DNNs are not included in the 12th identification information or that one or multiple LADN DNNs are included in the 15th identification information, the AMF may include, in the 12th identification information, an LADN DNN allowed by the network. In this regard, the LADN DNN allowed by the network may be an LADN DNN included in the DNN list held by the network, or an LADN DNN configured for the AMF. Furthermore, the LADN DNN allowed by the network may be an LADN DNN that is valid in the current registration area.

Note that the AMF may select and determine which of the 11th identification information to the 15th identification information is to be included in the REGISTRATION ACCEPT message, based on the identification information received, and/or the subscriber information, and/or the capability information of the network, and/or the operator policy, and/or the state of the network, and/or the registration information of the user, and/or the context held by the AMF, and/or the like.

The AMF can either include and transmit an SM message (for example, the PM session establishment accept message) in the REGISTRATION ACCEPT message, or transmit an SM message (for example, the PDU session establishment accept message) together with the REGISTRATION ACCEPT message. Note that the transmission method may be performed in a case that the SM message (for example, the PDU session establishment request message) is included in the registration request message and the 4th condition fulfillment determination is true. The transmission method may be performed in a case that the SM message (for example, the PDU session establishment request message) is included together with the registration request message and the 4th condition fulfillment determination is true. By performing such a transmission method as described above, the AMF can indicate that a procedure for SM is accepted in the registration procedure.

By transmitting the REGISTRATION ACCEPT message based on each piece of identification information received, and/or the subscriber information, and/or the capability information of the network, and/or the operator policy, and/or the state of the network, and/or the registration information of the user, and/or the context held by the AMF, and/or the like, the AMF may indicate that the request from the UE is accepted.

In addition, the AMF may transmit information indicating that a part of the request from the UE is rejected on the REGISTRATION ACCEPT message, or may transmit information indicating that a part of the request from the UE is rejected so as to indicate a reason of rejection of the part of the request from the UE. In addition, by receiving the information indicating that the part of the request of the UE is rejected, the UE may recognize the reason of rejection of the part of the request from the UE. Note that the reason for rejection may be information indicating that details indicated by the identification information received by the AMF are not allowed.

The UE receives the REGISTRATION ACCEPT message via the 5G AN (gNB) (S808). By receiving the REGISTRATION ACCEPT message, the UE can recognize that the request from the UE on the registration request message is accepted, and recognize details of various pieces of identification information included in the REGISTRATION ACCEPT message.

The UE can further transmit a registration complete message to the AMF via the 5G AN (gNB) as a response message to the REGISTRATION ACCEPT message (S810). Note that, in a case that the UE receives the SM message such as the PDU session establishment accept message, the UE may include and transmit the SM message such as the PDU session establishment complete message in the registration complete message, or may indicate that the procedure for SM has completed by including the SM message. Here, the registration complete message is a NAS message transmitted and/or received over the N1 interface; however, between the UE and the 5G AN (gNB), the registration complete message is transmitted and/or received on an RRC message.

The AMF receives the registration complete message via the 5G AN (gNB) (S810). Each apparatus completes the procedure of (A) of FIG. 6, based on transmission and/or reception of the REGISTRATION ACCEPT message and/or the registration complete message.

Next, a case that the 1st condition fulfillment determination is false will be described. In the procedure of (B) of FIG. 6, the AMF transmits a Registration reject message to the UE via the 5G AN (gNB) as a response message to the registration request message (S812). Here, the registration reject message is a NAS message transmitted and/or received over the N1 interface, however the registration reject message is included and transmitted and/or received in the RRC message between the UE and the 5G AN (gNB).

Note that the AMF may indicate that the request from the UE using the registration request message has been rejected by transmitting the registration reject message. In addition, the AMF may transmit information indicating a reason of rejection on the registration reject message, or may indicate a reason of rejection by transmitting the reason of rejection. Moreover, in response to receiving the information indicating the cause of the rejection of the request from the UE, the UE may recognize the cause of the rejection of the request from the UE. Note that the reason for rejection may be information indicating that details indicated by the identification information received by the AMF are not allowed.

The UE receives the registration reject message via the 5G AN (gNB) (S812). The UE can recognize that the request from the UE using the registration request message has been rejected and the content of various kinds of identification information included in the registration reject message by receiving the registration reject message. In a case that after transmitting the registration request message, the UE does not receive the registration reject message in spite of the elapse of a prescribed duration, the UE may recognize that the request from the UE is rejected. Each apparatus completes the procedure of (B) in the present procedure, based on transmission and/or reception of the registration reject message.

Note that the procedure of (B) of FIG. 6 may be initiated in a case that the procedure of (A) of FIG. 6 is cancelled. In the procedure of (A) of FIG. 6, in a case that the 4th condition fulfillment determination is true, the AMF may transmit an SM message indicating rejection, such as a PDU session establishment reject message, on the registration reject message, or may indicate that the procedure for SM is rejected by including an SM message indicating rejection. In that case, further, the UE may receive the SM message indicating rejection, such as the PDU session establishment reject message, or may recognize that the procedure for SM is rejected,

Each apparatus completes the registration procedure, based on completion of the procedure of (A) or (B) of FIG. 6. Note that each apparatus may transition to a state (RM_REGISTERED state) in which the UE is registered with the network, based on completion of the procedure of (A) of FIG. 6, may maintain a state (RM_DEREGISTERED state) in which the UE is not registered with the network or may transition to a state in which the UE is not registered with the network, based on completion of the procedure of (B) of FIG. 6. Transition of each apparatus to each state may be performed based on completion of the registration procedure, or may be performed based on establishment of a PDU session.

In addition, each apparatus may perform processing based on information transmitted and/or received in the registration procedure based on completion of the registration procedure. For example, in a case that information indicating that a part ot7the request from the UE is rejected is transmitted and/or received, a reason of rejection of the request from the UE may be recognized. In addition, each apparatus may perform the present procedure again or may perform the registration procedure on the core network_B or another cell based on the cause for the rejection of the request from the UE.

Moreover, the UE may store the identification information received along with the REGISTRATION ACCEPT message and/or the registration reject message or may recognize determination of the network, based on the completion of the registration procedure.

For example, in a case of receiving the 11th identification information, the UE may recognize that the network supports extension of the LADN service area. Furthermore, in a case of receiving the 11th identification information, the UE may recognize that the use of the extension of the LADN service area is allowed. In other words, in a case of receiving the 11th identification information, the UE may recognize the possibility of configuring, as the LADN service area, not only an area including one or multiple tracking areas but also an area different from the area including one or multiple tracking areas, or may recognize the possibility of using such an area as the LADN service area. In a case of receiving the 11th identification information, the UE may recognize that the LADN service area can be temporally changed. In these cases, the 11th identification information may be information indicating that the extension of the LADN service area is supported. Furthermore, in these cases, the UE may establish a PDU session for the LADN by using extended LADN information and/or an extended LADN service area, or may communicate with the LADN.

In contrast, in a case of receiving the 11th identification information indicating that the extension of the LADN service area is not supported, or in a case of not receiving the 11th identification information, the UE may recognize that the network does not support the extension of the LADN service area. Furthermore, in a case of receiving the 11th identification information indicating that the extension of the LADN service area is not supported, or in a case of not receiving the 11th identification information, the UE may recognize that the use of the extension of the LADN service area is not allowed. In other words, in a case of receiving the 11th identification information indicating that the extension of the LADN service area is not supported, or in a case of not receiving the 11th identification information, the UE may recognize the possibility of configuring, as the LADN service area, only an area including one or multiple tracking areas, or may recognize the possibility of using such an area as the LADN service area. In a case of receiving the 11th identification information indicating that the extension of the LADN service area is not supported, or in a case of not receiving the 11th identification information, the UE may recognize that the UE cannot temporally change the LADN service area. In these cases, the UE may establish a PDU session for the LADN by using the conventional LADN information and/or the conventional extended LADN service area, or may communicate with the LADN.

Furthermore, in a case of receiving the 11th identification information, the UE may recognize that the network supports the restriction on the use of extension of the LADN service area. Furthermore, in a case of receiving the 11th identification information, the UE may recognize that the use of the extension of the LADN service area is restricted. In this case, the 11th identification information may be information indicating that the restriction on the use of extension of the LADN service area is supported.

In contrast, in a case of receiving the 11th identification information indicating that the restriction on the use of extension of the LADN service area is not supported, or in a case of not receiving the 11th identification information, the UE may recognize that the network does not support the restriction on the use of extension of the LADN service area. Furthermore, in a case of receiving the 11th identification information indicating that the restriction on the use of extension of the LADN service area is not supported, or in a case of not receiving the 11th identification information, the UE may recognize that the use of extension of the LADN service area is not restricted. Note that, in a case that the use of extension of the LADN service area is restricted, the UE may be prohibited from using an extended LADN service area.

Furthermore, in a case of receiving the 12th identification information, the UE may recognize that the network supports the LADN or that the connection to the LADN is allowed. Furthermore, in a case of receiving the 12th identification information, the UE may recognize, or store in the context, a list of DNNs available for connection to the LADN and/or the LADN service area, corresponding to an area in which connection to the is enabled. Furthermore, in a case of receiving the 12th identification information, the UE may recognize one or multiple S-NSSAIs available for connection to the LADN, or may store the S-NSSAIs in the context. Furthermore, the UE may recognize that the S-NSSAIs available for connection to the LADN are associated with the DNNs available for connection to the LADN and/or the LADN service area, or may store, in the context, the S-NSSAIs available for connection to the LADN, the DNNs available for connection to the LADN, and/or the LADN service area in association with one another.

in other words, in a case of receiving the 12th identification information, the UE may recognize that a PDU session for the LADN associated with the LADN DNN received can be established or may recognize that a PDU session for the LADN associated with the LADN S-NSSAI received can be established. Furthermore, in a case of receiving the 12th identification information, the UE may recognize that a PDU session for the LADN associated with a combination of the LADN DNN and the LADN S-NSSAI received can be established.

Furthermore, in other words, in a case of receiving the 12th identification information, the UE may recognize that the LADN service area is an area in which a PDU session for the LADN associated with the LADN DNN can be established, or may recognize that the LADN service area is an area in which a PDU session for the LADN associated with the LADN S-NSSAI can be established. Furthermore, in a case of receiving the 12th identification information, the UE may recognize that the LADN service area received is an area in which a PDU session for the LADN associated with the combination of the LADN DNN and the LADN S-NSSAI can be established.

Furthermore, in a case of receiving the 12th identification information, the UE may store the LADN information received. In other words, the UE may store the LADN information received, based on the reception of the REGISTRATION ACCEPT message including the 12th identification information.

Furthermore, in a case of receiving the 12th identification information, the UE may recognize that the LAM information received is valid in some networks. In other words, the UE may recognize that the LADN information received is valid in some networks based on the reception of the REGISTRATION ACCEPT message including the 12th identification information.

Specifically, in a case that the UE is not operating in the SNPN access mode, the UE may recognize that the LADN information received is valid in the registered PLMN. Furthermore, in a case that the UE is not operating in the SNPN access mode, the UE may recognize that the LADN information received is valid in the registered PLMN and the equivalent PLMN. In this regard, the case where the UE is not operating in the SNPN access mode may mean a case where the UE is registered with the PLMN.

More specifically, in a case that the UE is not operating in the SNPN access mode, the UE may recognize that the LADN information received is valid in the TAI of the registered PLMN included in the LADN service area information. Furthermore, in a case that the LADN service area information includes the TAI of the equivalent PLMN, the UE may recognize that the LADN information received is valid in the TAI of the registered PLMN and in the TAI of the equivalent PLMN.

In other words, in a case that the UE is not operating in the SNPN access mode, the UE may recognize that the LADN information received is valid in the tracking area indicated by the TAI of the registered PLMN included in the LADN service area information. Furthermore, in a case that the LADN service area information includes the TAI of the equivalent PLMN, the UE may recognize that the LADN information received is valid in the tracking area indicated by the TAI of the registered PLMN and in the tracking area indicated by the TAI of the equivalent PLMN.

Furthermore, in other words, in a case that the LJE is not operating in the SNPN access mode, the UE may recognize that the LADN information received is valid for the Tracking Area identities (TAIs) of the registered PLMN. Furthermore, in a case that the LADN service area information includes the TAIs for the equivalent PLMN, the UE may recognize that the LADN information received is valid in the TAIs for the registered PLMN and in the TAIs for the equivalent PLMN. In this regard, the TAIs for the registered PLMN may be included in the LADN service area information, or may be included in the LADN service area information and transmitted and/or received.

In other words, in a case that the UE is not operating in the SNPN access mode, the UE may recognize that the LADN information received is valid in the tracking areas indicated by the TAIs for the registered. PLMN included in the LADN service area information. Furthermore, in a case that the LADN service area information includes the TAIs for the equivalent PLMN, the UE may recognize that the LADN information received is valid in the tracking area indicated by the TAIs for the registered PLMN and the tracking area indicated by the TAIs for the equivalent PLMN.

Furthermore, in a case that the UE is operating in the SNPN access mode, the UE may recognize that the LADN information received is valid in the registered SNPN. Furthermore, in a case that the UE is operating in the SNPN access mode, the UE may recognize that the LADN information received is valid in the registered SNPN and in the equivalent SNPN.

More specifically, in a case that the UE is operating in the SNPN access mode, the UE may recognize that the LADN information received is valid in the TAI of the registered SNPN included in the LADN service area information. Furthermore, in a case that the LADN service area information includes the TAI of the equivalent SNPN, the UE may recognize that the LADN information received is valid in the TAI of the registered SNPN and in the TAI of the equivalent SNPN.

in other words, in a case that the UE is operating in the SNPN access mode, the UE, may recognize that the LADN information received is valid in the tracking area indicated by the TAI of the registered. SNPN included in the LADN service area information. Furthermore, in a case that the LADN service area information includes the TAI of the equivalent SNPN, the UE may recognize that the LADN information received is valid in the tracking area indicated by the TAT of the registered SNPN and in the tracking area indicated by the TAI of the equivalent SNPN.

Furthermore, in other words, in a case that the UE is operating in the SNPN access mode, the UE may recognize that the LADN information received is valid for the Tracking Area Identities (TAIs) of the registered SNPN. Furthermore, in a case that the LADN service area information includes the TAIs for the equivalent SNPNs, the UE may recognize that the LADN information received is valid in the TAIs for the registered SNPN and in the TAIs for the equivalent SNPNs. In this regard, the TAIs for the registered SNPN may be included in the LADN service area information, or may be included in the LADN service area information and transmitted and/or received.

Furthermore, in other words, in a case that the UE is operating in the SNPN access mode, the UE may recognize that the LADN information received is valid in the tracking areas indicated by the TAIs for the registered SNPN. Furthermore, in a case that the LADN service area information includes the TAIs for the equivalent SNPNs, the UE may recognize that the LADN information received is valid in the tracking areas indicated by the TAIs for the registered SNPN and in the tracking areas indicated by the TAIs for the equivalent SNPNs.

In contrast, in a case of not receiving the 12th identification information, the UE may recognize that the network does not support the LADN or that no connection to the LADN is allowed. Furthermore, in a case of not receiving the 12th identification information, the UE may recognize that the LADN information stored by the UE is invalid, or may invalidate the LADN information stored by the UE. Furthermore, in a case of not receiving the 12th identification information, the UE may recognize that the LADN information stored by the UE needs to be deleted, or may delete the LAM information stored by the UE.

Furthermore, in a case of receiving the 12th identification information that is blank, the UE may recognize that the network does not support the LADN or that no connection to the LADN is allowed. Furthermore, in a case of receiving the 12th identification information that is blank, the UE may recognize that the LADN information stored by the UE is valid, or may invalidate the LADN information stored by the UE. Furthermore, in a case of receiving the 12th identification information that is blank, the UE may recognize that the LADN information stored by the UE needs to be deleted, or may delete the LADN information stored by the UE.

In these cases, in a case that the UE includes a PDU session for the LADN, then the UE may locally release the PDU session for the LADN. More specifically, in these cases, in a case that the UE includes PDU sessions for one or multiple LADNs, then the UE may locally release the PDU sessions for all the LADNs. Furthermore, in these cases, in a case that the UE includes PDU sessions for the LADNs, the PDU sessions for the LADNs may be released. More specifically, in these cases, in a case that the UE includes PDU sessions for one or multiple LADNs, the PDU sessions for all the LADNs may be released.

Furthermore, in these cases, in a case that the UE includes PDU sessions for the LADNs, the UE may release the PDU sessions for the LADNs by using the network request PDU session release procedure. Furthermore, in these cases, in a case that the UE includes PDU sessions for the LADNs, the UE may release the PDU sessions for the LADNs by using the UE request PDU session release procedure. Furthermore, in these cases, in a case that the UE includes PDU sessions for the LADNs, the UE may initiate the UE request PDU session release procedure to release the PDU sessions for the LADNs.

Furthermore, in these cases, in a case that the UE includes a PDU session associated with old LADN information, the UE may locally release the PDU session. Furthermore, in these cases, in a case that the UE includes one or multiple PDU sessions associated with the old LADN information, the UE may locally release all the PDU sessions associated with the old LADN information.

Furthermore, in a case that the AMF does not include the 12th identification information in the REGISTRATION ACCEPT message during the registration procedure for mobility and registration update, the UE may delete the old LADN information. In this case, in a case that the UE includes a PDU session for the LADN, then the UE may locally release the PDU session for the LADN.

More specifically, in a case that the AMF does not include the 12th identification information in the REGISTRATION ACCEPT message during the registration procedure for mobility and registration update, the UE may delete the old LADN information, In this case, in a case that the UE includes PDU sessions for one or multiple LADNs, the UE may locally release the PDU sessions for all the LADNs.

Furthermore, in a case that the AMF does not include the 12th identification information in the REGISTRATION ACCEPT message during the registration procedure for mobility and registration update, the UE may delete the old LADN information. In this case, in a case that the UE includes a PDU session for the LADN, the PDU session for the LADN may be released.

More specifically, in a case that the AMF does not include the 12th identification information in the REGISTRATION ACCEPT message during the registration procedure for mobility and registration update, the UE may delete the old LADN information. In this case, in a case that the UE includes PDU sessions for one or multiple LADNs, the PDU sessions for all the LADNs may be released.

Furthermore, in a case that the AMF does not include the 12th identification information in the REGISTRATION ACCEPT message during the registration procedure for mobility and registration update, the UE may delete the old LADN information. In this case, in a case that the UE includes a PDU session for the LADN, the UE may release the PDU session for the LADN by using the network request PDU session release procedure.

Furthermore, in a case that the AMF does not include the 12th identification information in the REGISTRATION ACCEPT message during the registration procedure for mobility and registration update, the UE may delete the old LADN information. In this case, in a case that the UE includes a PDU session for the LADN, the UE may release the PDU session for the LADN by using the UE request PDU session release procedure.

Furthermore, in a case that the AMF does not include the 12th identification information in the REGISTRATION ACCEPT message during the registration procedure for mobility and registration update, the UE may delete the old LADN information. In this case, in a case that the UE includes a PDU session for the LADN, the UE may initiate the UE request PDU session release procedure to release the PDU session for the LADN.

Furthermore, in a case that the AMF does not include the 12th identification information in the REGISTRATION ACCEPT message during the registration procedure for mobility and registration update, the UE may delete the old LADN information. In this case, in a case that the UE includes a PDU session associated with the old LADN information, the UE may release the PDU session locally.

Furthermore, in a case that the AMF does not include the 12th identification information in the REGISTRATION ACCEPT message during the registration procedure for mobility and registration update, the UE may delete the old LADN information. In this case, in a case that the UE includes one or multiple PDU sessions associated with the old LADN information, the UE may locally release all the PDU sessions associated with the old LADN information.

Furthermore, in a case of deleting the old information, the UE may be recognized as being located outside the LADN service area. Furthermore, the UE may maintain a PDU session for the LADN even in a case that the UE is located outside the LADN service area. In particular, even in a case that the UE is located outside the LADN service area, the UE may maintain a PDU session for the LADN until the UE receives a PDU session release command message. Note that the PDU session release command message may be a message transmitted. and/or received in the network request PDU session release procedure or a message transmitted and/or received in the UE request PDU session release procedure.

In this regard, the PDU session for the LADN to be released may be a PDU session associated with the old LADN information. In other words, the PDU session for the LADN to be released may be a PDU session associated with the LADN information to be deleted.

Furthermore, the network request PDU session release procedure may be a procedure initiated by the SMF transmitting the PDU session release command message to the UE. In the network request PDU session release procedure, the UE may release the PDU session based on the reception of the PDU session release command message from the SMF and/or completion of the network request PDU session release procedure.

Furthermore, the UE request PDU session release procedure may be a procedure initiated by the UE transmitting the PDU session release request message to the SMF. The UE may receive the PDU session release command message from the SMF as a response message for the PDU session release request message in the UE request PDU session release procedure, or may release the PDU session based on the reception of the PDU session release command message from the SMF and/or the completion of the UE request PDU session release procedure.

Note that each apparatus including a PDU session may mean each apparatus having established a PDU session. Specifically, the UE including a PDU session may mean the UE having established a PDU session. Furthermore, the AMF including a PDU session may mean the AMF session having established a PDU session. Furthermore, the SMF including a PDU session may mean the SMF having established a PDU session.

Moreover, based on the 12th identification information and/or the 15th identification information, the UF may recognize whether the LADN DNN requested by the UE is available or may recognize whether the registration procedure for requesting new LADN information for the same LADN DNN is prohibited.

For example, in a case that the LADN DNN requested by the UE is included in the 12th identification information, the UE may recognize that the LADN DNN requested by the UE is unavailable, In contrast, in a case that the LADN DNN requested by the UE is not included in the 12th identification information, and/or in a case that the LADN DNN requested by the UE is included in the 15th identification information, the UE may recognize that the LADN DNN requested by the UE is unavailable. In a case that an LADN DNN other than that requested by the UE is included in the 12th identification information, the UE may recognize that the LADN DNN requested by the UE is unavailable, or may recognize an LADN DNN which is other than that requested by the UE and which is available. Note that in a case of recognizing that the LADN DNN is available, the UE may initiate the PDU session establishment procedure using the LADN DNN while the UE is in a state of being located inside the LADN service area associated with the LADN DNN.

Furthermore, in a case that one or multiple LADN DNNs are present that are included in the 2nd identification information and that are not included in the 12th identification information, the UE may be prohibited from initiating again the registration procedure for requesting new LADN information for the LADN DNN. In other words, in a case that the 12th. identification information is received that lacks one or multiple of the LADN DNNs included in the 2nd identification information, the UE may be prohibited from initiating again the registration procedure for requesting new LADN information for the LADN DNN.

Furthermore, in a case that the 15th identification information is included in the REGISTRATION ACCEPT message, the UE may be prohibited from initiating again the registration procedure for requesting new LADN information for the LADN DNN included in the 15th identification information. In other words, in a case that one or multiple LADN DNNs are present that are included in the 15th identification information, the UE may be prohibited from initiating again the registration procedure for requesting new LADN information for the LADN DNN.

Note that the registration procedure may be a registration procedure for mobility and registration update. Furthermore, the registration procedure may be a procedure for requesting new LADN information. Furthermore, in the registration procedure, in a case of receiving the LADN information, the UE may store the LADN information received. Note that in the registration procedure, by transmitting the registration request message including the 2nd identification information, the UE may request new LADN information, or may acquire LADN information from the network. In the registration procedure, even in a case of transmitting a registration request message not including the 2nd identification information, the UE may acquire LADN information from the network.

In this regard, the UE may initiate the registration procedure to synchronize the LADN information with the network. Furthermore, the UE may initiate the registration procedure to avoid a failure due to the outside of the LADN service area.

Furthermore, in a case that one or multiple LADN DNNs are present that are included in the 2nd identification information and not included in the 12th identification information and further that the UE stores the LADN information of the LADN DNNs, then the UE may delete the LADN information of the LADN DNNs. In other words, in a case that the 12th identification information is received that lacks one or multiple of the LADN DNNs included in the 2nd identification information and that the UE stores the LADN information of the LADN DNN, then the UE may delete the LADN information of the LADN DNN.

Furthermore, in a case that the 15th identification information is included in the REGISTRATION ACCEPT message and further that the UE stores the LADN information of the LADN DNN included in the 15th identification information, then the UE may delete the LADN information of the LADN DNN. In other words, in a case that one or multiple LADN DNNs are present that are included in the 15th identification information and further that the UE stores the LADN information of the LADN DNNs, then the UE may delete the LADN information of the LADN DNNs.

In contrast, in a case that the UE stores the LADN information of the LADN DNN not included in the 2nd identification information, the UE need not delete the LADN information of the LADN DNN.

By not including an LADN DNN in the 12th identification information, the AMF may indicate that the LADN information of the LADN DNN, stored by the UE, needs to be deleted. Furthermore, by including an LADN DNN in the 15th identification information, the AMF may indicate that the LADN information of the LADN DNN, stored by the UE, needs to be deleted.

Furthermore, in a case of receiving the 13th identification information, the UE may recognize the granularity of the LADN service area. More specifically, in a case of receiving the 13th identification information together with the 12th identification information, the UE may recognize the granularity of the LADN service area indicated by the LADN service area information included in the 12th identification information, or may store the granularity in the context association with the LADN service area information. Specifically, in a case of receiving the 13th identification information together with the 12th identification information, the UE may recognize, in connection with the granularity of the LADN service area, that the LADN service area indicated by the LADN service area information is an area including one or multiple tracking areas, or may recognize that the LADN service area is an area differing from the area including one or multiple tracking areas. Furthermore, in a case of receiving the 13th identification information together with the 12th identification information, the UE may recognize that the tracking area ID list is included as the LADN service area information, or that information requiring the assistance of the RAN is included, or that information not requiring the assistance of the RAN is included.

In contrast, in a case of not receiving the 13th identification information, the UE may use a default granularity as the granularity of the LADN service area. Furthermore, even in a case of receiving the 13th identification information, the UE may ignore the 13th identification information received and may use the default granularity as the granularity of the LADN service area in a case that the 13th identification information is invalid and/or that the UE does not support the extension of the LADN service area. In this regard, the default granularity may be a granularity preconfigured for the UE or a granularity indicated by the information previously received from the network. Furthermore, for the default granularity, the LADN service area may be an area including one or multiple tracking areas, and the LADN service area information may be a tracking area ID list.

Note that in a case that information indicating multiple LADNs is included in the 12th identification information, the UE may store the granularity of the LADN service area in the context for each piece of information indicating the LADNs in association with information indicating the LADNs. Furthermore, in a case that multiple pieces of LADN service area information are included in the 12th identification information, the UE may store the granularity of the LADN service area in the context for each piece of LADN service area information in association with the LADN service area information.

Furthermore, in a case of receiving the 14th identification information, the UE may recognize the duration in which the LADN service area is valid, More specifically, in a case of receiving the 14th identification information together with the 12th identification information, the UE may recognize the duration in which the LADN service area indicated by the LADN service area information included in the 12th identification information is valid, or may store the duration in the context in association with the LADN service area information.

In contrast, in a case of not receiving the 14th identification information, the UE may use a default duration as the duration in which the LADN service area is valid. Furthermore, even in a case of receiving the 14th identification information, the UE may ignore the 14th identification information received and may use the default duration as the duration in which the LADN service area is valid in a case that the 14th identification information is invalid and/or that the UE does not support the extension of the LADN service area. In this regard, the default duration may be a duration configured in advance for the UE, or may be a duration indicated by the information received from the network. Furthermore, the default duration may be a duration until the LADN information is updated.

Note that in a case that information indicating multiple LADNs is included in the 12th identification information, the UE may store the duration in which the LADN service area is valid, in the context for each piece of information indicating the LADN in association with the information indicating the LADN. Furthermore, in a case multiple pieces of LADN service area information are included in the 12th identification information, the UE may store the duration in which the LADN service area is valid, in the context for each piece of LADN service area information in association with the LADN service area information,

Furthermore, in a case of receiving the 11th identification information, and/or the 13th identification information, and/or the 14th identification information, together with the 12th identification information, the UE may recognize that extended LADN information and/or an extended LADN service area is available, and may store, in the context, the LADN information and/or LADN service area information available. Furthermore, in this case, the UE may recognize that the LADN information received is the extended LADN information, or may store the LADN information received in the context as the extended LADN information. Furthermore, in this case, the UE may recognize that the LADN service area indicated by the LADN service area information received is the extended LADN service area, or may store the LADN service area information received in the context as the LADN service area information indicating the extended LADN service area. In this case, the 11th identification information may be information indicating that the extension of the LADN service area is supported, and the 12th identification information may be the extended LADN information.

In contrast, in a case of receiving the 11th identification information and/or the 12th identification information, while not receiving the 13th identification information and/or the 14th identification information, and/or in a case of receiving the 12th identification information, while not receiving the 11th identification information, and/or the 13th identification information, and/or the 14th identification information, the UE may recognize that no extended LADN information and/or extended LADN service area is available. Furthermore, in this case, the UE may recognize that the conventional LADN information and/or the conventional LADN service area is available, or may store, in the context, the LADN information and/or the LADN service area information available. Furthermore, in this case, the UE may recognize that the LADN information received is the conventional LADN information, or may store the LADN information received in the context as the conventional LADN information. Furthermore, in this case, the UE may recognize that the LADN service area indicated by the LADN service area information received is the conventional LADN service area, or may store, in the context, the LADN service area information received as the LADN service area information indicating the conventional LADN service area. In this case, the 11th identification information may be information indicating that the extension of the LADN service area is not supported, and the 12th identification information may be the conventional LADN information.

Furthermore, in a case of receiving the 12th identification information while the UE is not in a state of supporting the extension of the LADN service area, the UE may recognize that at least one of extended LADN information and extended LADN service area is not available. Furthermore, in this case, the UE may recognize that the conventional LADN information and/or the conventional LADN service area is available, or may store, in the context, the LADN information and/or the LADN service area information available. Furthermore, in this case, the UE may recognize that the LADN information received is the conventional LADN information in this case, or may store the LADN information received in the context as conventional LADN information. Furthermore, in this case, the UE may recognize that the LADN service area indicated by the LADN service area information received is the conventional LADN service area, or may store, in the context, the LADN service area information received as the LADN service area information indicating the conventional LADN service area. In this case, the 12th identification information may be the conventional extended LADN information.

In addition, in a case of receiving at least the 12th identification information and being located inside the LADN service area indicated by the information received, the UE may recognize that a PDU session for the LADN can be established and may initiate the PDU session establishment procedure for establishing a PDU session for the LADN. In other words, in a case of receiving at least the 12th identification information and being located outside the LADN service area indicated by the information received, the UE may recognize that a PDU session for the LADN cannot be established or the PDU session establishment procedure for establishing a PDU session for the LADN may be prohibited.

Furthermore, based on update of the LADN information and/or determination of whether the UE is located inside the LADN service area, the UE may initiate the PDU session establishment procedure to establish a PDU session for the LADN. Specifically, based on the determination that the UE is located inside the LADN service area, the UE may initiate the PDU session establishment procedure to establish a PDU session for the LADN. In contrast, based on the determination that the UE is located outside the LADN service area, each apparatus may release the PDU session for the LADN or release user plane resources associated with the PDU session for the LADN.

In this regard, the determination of whether the UE is located inside the LADN service area may be performed based on the extended LADN service area or on the conventional LADN service area. In other words, in a case of storing the extended LADN service area, each apparatus may determine whether the UE is located inside the LADN service area, based on the extended LADN service area. In contrast, in a case of storing the conventional LADN service area, each apparatus may determine whether the UE is located inside the LADN service area based on the conventional LADN service area.

Furthermore, in a case that the stored. LADN service area is the tracking area ID list, whether the UE is located inside the LADN service area may be determined based on a comparison between the LADN service area information stored by the UE and a tracking area ID acquired from the RAN. Specifically, in a case that the tracking area ID acquired from the RAN is included in the LADN service area information stored by the UE, the UE may recognize that the UE is located inside the LADN service area and store this information. In contrast, in a case that the tracking area ID acquired from the RAN is not included in the LADN service area information stored by the UE, the UE may recognize that the UE is located outside the LADN service area and store this information.

Furthermore, in a case that the stored LADN service area is information requiring the assistance of the RAN, whether the UE is located inside the LADN service area may be determined based on a comparison between the LADN service area information stored by the UE and information acquired from the RAN. Specifically, in a case that the information acquired from the RAN is included in the LADN service area information stored by the UE, the UE may recognize that the UE is located inside the LADN service area and store this information. In contrast, in a case that the information acquired from the RAN is not included in the LADN service area information stored by the UE, the UE may recognize that the UE is located outside the LADN service area and store this information.

Furthermore, in a case that the stored LADN service area is information not requiring the assistance of the RAN, whether the UE is located inside the LADN service area may be determined based on a comparison between the LADN service area information stored by the UE and information acquired from other than the RAN. Specifically, in a case that the information acquired from other than the RAN is included in the LADN service area information stored by the UE, the UE, may recognize that the UE is located inside the LADN service area and store this information. In contrast, in a case that the information acquired from other than the RAN is not included in the LADN service area information stored by the UE, the UE, may recognize that the UE is located outside the LADN service area and store this information.

The determination of whether the UE is located inside the LADN service area may be performed based on transmission and/or reception of the control message transmitted from the network to the UE. Specifically, the UE may recognize, that the UE is located inside the LADN service area based on the reception of the control message from the network, and may store this information. In contrast, the UE may recognize, that the UE is located outside the LADN service area based on the reception of the control message from the network, and may store this information. In this regard, the control message transmitted from the network to the UE may be, for example, a control message for Location Services (LCS). Note that the determination of whether the UE is located inside the LADN service area is not limited to the determination described above.

Furthermore, the UE may recognize that a PDU session for the LADN can be established within the duration when the LADN service area is valid, or may initiate the PDU session establishment procedure for establishing a PDU session for the LADN. In other words, in a case that the current time is not within the duration when the LADN service area is valid, the UE may recognize that a PDU session for the LADN cannot be established or the UE may be prohibited from performing the PDU session establishment procedure for establishing a PDU session for the LADN.

Furthermore, based on the update of the LADN information and/or the determination of validation of the LADN service area, the UE may initiate the PDU session establishment procedure for establishing a PDU session for the LADN. Specifically, based on the validation of the LADN service area, the UE, may initiate the PDU session establishment procedure for establishing a PDU session for the LADN. In contrast, based on invalidation of the LADN service area, each apparatus may release the PDU session for the LADN established associated with the invalidated LADN service area, or release the user plane resources associated with the PDU session for the LADN.

In this regard, the determination of validation of the LADN service area may be performed based on the information indicating the duration when the LADN service area is valid. Specifically, the UE may compare the current time with the duration when the LADN service area is valid, and in a case that the current time is within the duration when the LADN service area is valid, may determine that the LADN service area is valid. In contrast, the UE may compare the current time with the duration when the LADN service area is valid, and in a case that the current time is not within the duration when the LADN service area is valid, may determine that the LADN service area is invalid. Furthermore, based on the beginning of the duration when the LAN service area indicated by information received is valid, the UE may validate the associated LADN service area. In contrast, based on the end of the duration when the LADN service area indicated by the information received is valid, the UE may invalidate the associated LADN service area.

The determination of validation of the LADN service area may be implemented based on the reception of the control message from the network. Specifically, the UE may determine that the LADN service area is valid in a case that the UE receives the control message from the network. Furthermore, the UE may determine that the LADN service area is not valid in a case that the UE cannot receive the control message from the network. In contrast, the UE may determine that the LADN service area is not valid in a case that the UE receives the reception of the control message from the network. Furthermore, the UE may determine that the LADN service area is valid in a case that the US cannot receive the control message from the network. Furthermore, the UE may validate the LADN service area based on the reception of the control message from the network. In contrast, the UE may invalidate the LADN service area based on the reception of the control message from the network. Note that the determination of validation of the LADN service area is not limited to the determination described above.

### 3.2.2 PDU Session Establishment Procedure

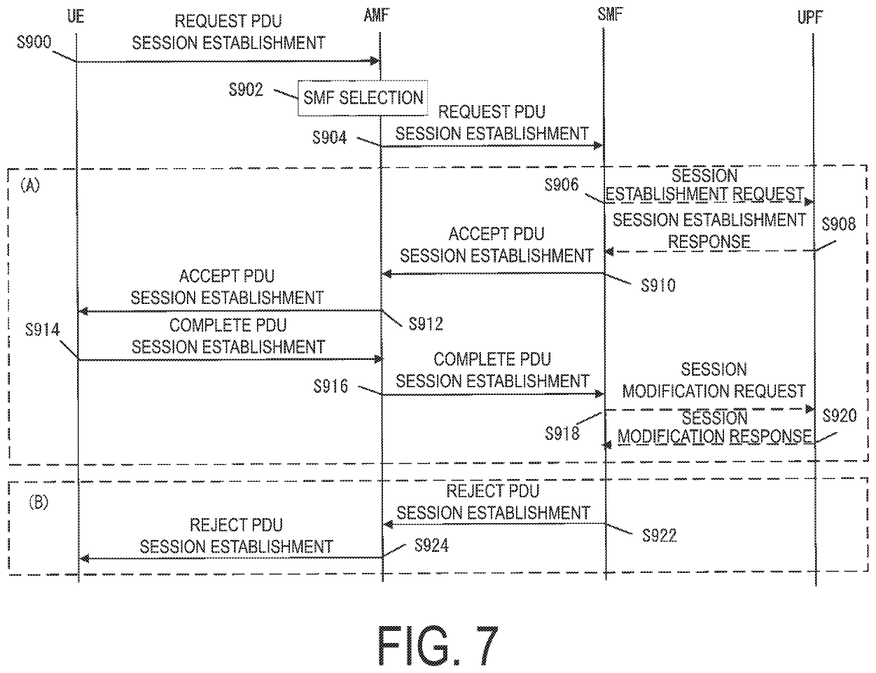

Next, an overview of the PDU session establishment procedure performed for establishing a PDU session with respect to the DN will be described with reference to FIG. 7. The PDU session establishment procedure is a procedure in the 5GS. The present procedure hereinafter refers to the PDU session establishment procedure. The PDU session establishment procedure is a procedure for each apparatus to establish a PDU session. Note that each apparatus can initiate the PDU session establishment procedure at any timing after the registration procedure has completed and the state enters the registered state. Each apparatus may be able to perform the PDU session establishment procedure during the registration procedure. Each apparatus may establish a PDU session based on completion of the PDU session establishment procedure. Note that the PDU session establishment procedure may be a procedure initiated by the UE, or may be a procedure initiated in response to a request from the UE. Each apparatus can establish multiple PDU sessions by performing the PDU session establishment procedure multiple times.

In this regard, in a case that the PDU session establishment procedure is a PDU session establishment procedure for establishing a PDU session for the LADN, each apparatus may establish a PDU session for the LADN based on completion of the PDU session establishment procedure. In other words, in a case that the PDU session establishment procedure is a PDU session establishment procedure using the LADN DNN, each apparatus may establish a PDU session for the LADN based on the completion of the PDU session establishment procedure.

In addition, in a case that the UE is located in an area in which connection to an LADN is possible and/or a case that the UE is located in an LADN service area, the UE may initiate the PDU session establishment procedure in order to establish a PDU session for the LADN. In contrast, in a case that the UE is located outside the LADN service area, the UE may be prohibited from performing the PDU session establishment procedure for establishing a PDU session for the LADN.

In other words, in a case that the UE is located in an area in which connection to the LADN is enabled and/or that the UE is located in the LADN service area, each apparatus may perform the PDU session establishment procedure in order to establish a PDU session for the LADN. In contrast, in a case that the UE is located outside the LADN service area, the network apparatus may reject the request for the PDU session establishment procedure for establishing a PDU session for the LADN.

First, the UE transmits a NAS message including a PDU session establishment request message to the SMF via the 5G AN (gNB) and the AMF (S900) (S902) (S904), and thereby initiates the PDU session establishment procedure.

Specifically, the UE transmits a NAS message including a PDU session establishment request message to the AMF via the 5G AN (gNB) via the N1 interface (S900). Note that the NAS message including the PDU session establishment request message may be an MM message. Furthermore, the MM message may be an uplink NAS transport (UL NAS TRANSPORT) message, In this regard, the expression “the PDU session establishment request message includes identification information and/or a value” may mean that the identification information and/or the value may be included in the MM message including the PDU session establishment request message.

In this regard, the UE can include at least the 26th identification information in the PDU session establishment request message aid/or the NAS message for transmission. However, the UE may include, for transmission, the identification information in a control message different from the ones described above, e.g., a control message from a layer lower than the RRC layer (for example, the MAC layer, the RLC layer, or the PDCP layer). Being included in these messages, these pieces of identification information may indicate a request from the UE. Two or more pieces of identification information of these pieces of identification information may be configured as one or more pieces of identification information.

Furthermore, by transmitting the 26th identification information, the UE may indicate a request to establish a PDU session associated with the DNN indicated by the 26th identification information or may indicate the DNN required by the UE. Note that the 26th identification information may be a DNN that identifies a DN that supports one or multiple functions indicated by the identification information transmitted and/or received together with the 26th identification information. Furthermore, the 26th identification information may be a DNN received in the registration procedure or the LADN.

In this regard, in a case that the PDU session establishment procedure is a PDU session establishment procedure for establishing a PDU session for the LADN, the UE may include, in the PDU session establishment request message, an LADN DNN corresponding to a DNN available in connection to the LADN and transmit the PDU session establishment request message. Furthermore, in a case that the PDU session establishment procedure is a PDU session establishment procedure for establishing a PDU session for the LADN, the UE may include, in the PDU session establishment request message, an LADN S-NSSAI corresponding to an S-NSSAI available in connection to the LADN and transmit the PDU session establishment request message, or may also include an S-NSSAI associated with the LADN DNN in the PDU session establishment request message for transmission.

In these cases, the UE may select the LADN DNN to be included in the PDU session establishment request message from among the LADN DNNs included in the LADN information received before performance of the PDU session establishment procedure, or may select the LADN DNN to be included in the PDU session establishment request message from among the LADN DNNs stored by the UE. Furthermore, the UE may select the LADN S-NSSAI to be included in the PDU session establishment request message from among the LADN S-NSSAIs included in the LADN information received before the PDU session establishment procedure is performed, or may select the LADN S-NSSAI to be included in the PDU session establishment request message from among the LADN S-NSSAIs stored by the UE. Furthermore, the UE may select the S-NSSAI associated with the LADN DNN to be included in the PDU session establishment request message, and include the selected S-NSSAI in the PDU session establishment request message.

Furthermore, in a case that multiple LADN DNN is included and/or stored in LADN information received before the PDL session establishment procedure is performed, the UE may select the LADN DNN based on the LADN service area information, and transmit the selected LADN DNN to the PDU session establishment request message. In addition, in a case that multiple LADN S-NSSAIs are included and/or stored in the LADN information received before the PDU session establishment procedure is performed, the UE may select an LADN S-NSSAI based on the LADN service area information, and transmit the selected LADN S-NSSAI to the PDU session establishment request message. More specifically, in a case that information indicating multiple LADNs is included in the LADN information received before the PDU session establishment procedure is performed and/or that the information indicating multiple LADNs is stored, the UE may select information indicating the LADN based on the LADN service area information, include, in the PDU session establishment request message, the LADN DNN and/or the LADN S-NSSAI included in the information indicating the selected LADN data, and transmit the PDU session establishment request message.

After the AMF receives the NAS message including the PDU session establishment request message (S900), the AMF extracts the PDU session establishment request message from the NAS message, and selects an SMF as a transfer destination of the PDU session establishment request message (S902). Note that the AMF may select the SMF as a transfer destination based on each piece of identification information included in the PDU session establishment request message and/or the NAS message, and/or the subscriber information, and/or the capability information of the network, and/or the operator policy, and/or the state of the network, and/or the registration information of the user, and/or the context held by the AMF, and/or the like.

The AMF transfers the PDU session establishment request message to the selected SMF via the N11 interface (S904).

After the SMF receives the PDU session establishment request message (S904), the SMF recognizes various pieces of identification information included in the PDU session establishment request message. Then, the SMF performs the 3rd condition fulfillment determination. The 3rd condition fulfillment determination is a condition fulfillment determination for determining whether or not the SMF accepts the request from the UE. In the third condition fulfillment determination, the SMF determines whether the third condition fulfillment determination is true or false. In a case that the 3rd condition fulfillment determination is true, the SMF initiates the procedure of (A) of FIG. 7, whereas in a case that the 3rd condition fulfillment determination is false, the SW initiates the procedure of (B) of FIG. 7.

Note that the 3rd condition fulfillment determination may be performed based on the PDL session establishment request message, and/or each piece of identification information included in the PDU session establishment request message, and/or the subscriber information, and/or the capability information of the network, and/or the operator policy, and/or a state of the network, and/or the registration information of the user, and/or the context held by the SMF, and/or the like. For example, in a case that the network allows the request from the UE, the 3rd condition fulfillment determination may be true. In a case that the network does not allow the request from the UE, the 3rd condition fulfillment determination may be false. In addition, in a case that a destination network to which the UE is to be connected and/or an apparatus in the network supports the function requested by the UE, the 3rd condition fulfillment determination may be true, whereas in a case that the destination network and/or the apparatus does not support the function requested by the UE, the 3rd condition fulfillment determination may be false. In addition, in a case that the transmitted and/or received identification information is allowed, the 3rd condition fulfillment determination may be true, whereas in a case that the transmitted and/or received identification information is not allowed, the 3rd condition fulfillment determination may be false. Note that the conditions for determining true or false of the third condition fulfillment determination need not be limited to the conditions described above.

Next, steps of a case that the 3rd condition fulfillment determination is true, that is, steps of the procedure of (A) of FIG. 7, will be described. The SMF selects destination UPF(s) with which a PDU session is to be established and transmits a session establishment request message to the selected UPF(s) via the N4 interface (906), and thereby initiates the procedure of (A) of FIG. 7.

In this regard, the SMF may select one or more UPFs based on each piece of identification information acquired based on the reception of the PDU session establishment request message, and/or the subscriber information, and/or the capability information of the network, and/or the operator policy, and/or the state of the network, and/or the registration information of the user, and/or the context held by the SMF, and/or the like. Note that, in a case that multiple UPFs are selected, the SMF may transmit the session establishment request message to each of the UPFs.

The UPF receives the session establishment request message from the SMF via the N4 interface (S906), and creates a context for the PDU session. In addition, the UPF transmits a session establishment response message to the SMF via the N4 interface, based on reception of the session establishment request message and/or creation of the context for the PDU session (S908).

The SMF receives the session establishment response message from the UPF via the N4 interface as a response message to the session establishment request message (S908). The SMF may perform address allocation for an address to be allocated to the UE, based on reception of the PDU session establishment request message and/or selection of the UPF, and/or reception of the session establishment response message.

The SMF transmits a PDU session establishment accept message to the UE via the AMF, based on reception of the PDU session establishment request message, and/or selection of the UPF, and/or reception of the session establishment response message, and/or completion of address allocation of an address to be allocated to the UE (S910) (S912).

Specifically, after the SMF transmits the PDU session establishment accept message to the AMF via the N11 interface (S910), the AMF that has received the PDU session establishment request message transmits a NAS message including the PDU session establishment accept message to the UE via the N1 interface (S912). Note that the PDU session establishment accept message may be a NAS message, and may be a response message to the PDU session establishment request. Furthermore, the PDU session establishment accept message may be included and transmitted and/or received in the MM message via the N1 interface.

Furthermore, the NAS message may be a NAS message or a downlink NAS transport (DL NAS TRANSPORT) message. In this regard, the expression “the PDU session establishment accept message includes identification information and/or a value” may mean that the identification information and/or the value is included in the MM message including the PDU session establishment accept message. The PDU session establishment accept message can indicate that establishment of a PDU session is accepted.

Here, by transmitting the PDU session establishment accept message, the SMF and the AMF may indicate that the request from the UE represented by the PDU session establishment request is accepted.

The SW and the AMF may transmit the PDU session establishment accept message including at least the 36th identification information. Note that, by transmitting these pieces of identification information, the SMF and the AMF may indicate that the network supports each function, or may indicate that the request from the UE is accepted. In addition, two or more pieces of identification information of these pieces of identification information may be configured as one or more pieces of identification information. Note that information indicating support of each function and information indicating a request for use of each function may be transmitted and/or received as the same piece of identification information, or may be transmitted and/or received as different pieces of identification information.

In addition, by transmitting the 36th identification information, the SMF and the AMF may indicate acceptance of the request to establish a PDU session associated with the DNN indicated by the 36th identification information or indicate that the PDU session is to be established. Furthermore, the SMF and the AMF may indicate that the 36th identification information is to transmitted, and the DNN selected and determined by the network. Note that the 36th identification information may be a DNN that identifies a DN that supports one or multiple functions indicated by the identification information transmitted and/or received together with the 36th identification information. Furthermore, the 36th identification information may be a DNN transmitted in the registration procedure, or may be the LADN.

Note that the SMF and the AMF may select and determine whether to include at least the 36th identification information in the PDU session establishment accept message, based on each piece of identification information received, and/or the subscriber information, and/or the capability information of the network, and/or the operator policy, and/or the state of the network, and/or the registration information of the user, and/or the context held by the AMF, and/or the like.

The SMF and the AMF can include the selected and/or allowed PDU session ID in the PDU session establishment accept message. The SMF and the AMF can specify a PDU session type indicating a type of the selected and/or allowed PDU session, As the PDU session type, as described above, one of IPv4, IPv6, IP, Ethernet, and Unstructured can be specified. The SMF and the AMF can include the SSC mode of the selected and/or allowed PDU session in the PDU session establishment accept message.

In addition, the SMF and the AMF can include an approved QoS rule group in the PDU session establishment accept message. Note that the approved QoS rule group may include one or multiple QoS rules. In addition, in the present procedure, in a case that multiple QoS flows and/or user plane radio bearers are established, the approved QoS rule group may include multiple QoS rules. In contrast, in the present procedure, in a case that only one QoS flow and/or user plane radio bearer is established, the approved QoS rule group may include one QoS rule.

In addition, the SMF may transmit information indicating that a part of the request from the UE is rejected on the PDU session establishment accept message, or may transmit information indicating that a part, of the request from the UE is rejected so as to indicate a reason of rejection of the part of the request from the UE. In addition, by receiving the information indicating that the part of the request of the UE is rejected, the UE may recognize the reason of rejection of the part of the request from the UE. Note that the cause of the rejection may be information indicating that the contents indicated by the identification information received by the SMF have not been allowed.

The UE receives, from the AMF via the N1 interface, the NAS message including the PDU session establishment accept message (S912). Based on the reception of the PDU session establishment accept message and/or the reception of the NAS message including the PDU session establishment accept message, the UE may transmit a PDU session establishment complete message to the SMF via the AMF (S914) (S916). By receiving the PDU session establishment accept message, the UE can detect that the request from the UE represented by the PDU session establishment request is accepted.

Specifically, the UE transmits the PDU session establishment complete message to the AMF via the N1 interface (S914). After the AMF receives the PDL session establishment complete message from the UE, the AMF transmits a PDU session establishment complete message to the SMF via the N11 interface (S916).

Note that the PDU session establishment complete message that is transmitted by the AMF to the SMF may be a response message to the PDU session establishment accept message that is transmitted from the SMF to the AMF in S910. The PDU session establishment complete message may be a NAS message. The PDU session establishment complete message may be a message indicating that the PDU session establishment procedure completes.

After the SMF receives the PDU session establishment complete message from the AMF via the N11 interface (S916), the SMF can perform the 2nd condition fulfillment determination, The 2nd condition fulfillment determination is a condition fulfillment determination for determining a type of a transmitted and/or received message on the N4 interface. In a case that the 2nd condition fulfillment determination is true, the SMF transmits a session modification request message to the UPF via the N4 interface (S918), and then receives a session modification accept message transmitted from the UPF as a response message to the session modification request message (S920). In a case that the 2nd condition fulfillment determination is false, the SMF transmits a session establishment request message to the UPF via the N4 interface (S918), and then receives a session modification accept message transmitted from the UPF as a response message to the session establishment request message (S920).

Note that the 2nd condition fulfillment determination may be performed based on whether or not a session on the N4 interface for a PDU session is established. For example, in a case that a session on the N4 interface for a PDU session is established, the 2nd condition fulfillment determination may be true, whereas in a case that a session on the N4 interface for a PDU session is not established, the 2nd condition fulfillment determination may be false. Note that the conditions for determining true or false of the 2nd condition fulfillment determination need not be limited to the conditions described above.

Each apparatus completes the procedure of (A) in the PDU session establishment procedure, based on transmission and/or reception of the PDU session establishment complete message, and/or transmission and/or reception of the session modification response message, and/or transmission and/or reception of the session establishment response message. In a case that the procedure of (A) of the present procedure has completed, the UE is in a state in which a PDU session with respect to the DN is established. In this regard, in a case that the PDU session establishment procedure is a PDU session establishment procedure for establishing a PDU session for the LADN, each apparatus may establish a PDU session for the LADN based on the completion of the procedure of (A) in the present procedure.

Next, steps of the procedure of (B) in the PDU session establishment procedure will be described. The SMF transmits the PDU session establishment reject message to the UE via the AMF (S922) (S924). Specifically, the SMF transmits the PDU session establishment reject message to the AMF via the N11 interface (S922). After the AMF receives the PDU session establishment request message from the SMF via the N11 interface (S922), the AMF transmits the PDU session establishment reject message to the UE via the N1 interface (S924).

Note that the PDU session establishment reject message may be the NAS message or the SM message transmitted from the SMF to the UE. The PDU session establishment reject message may be a message indicating that establishment of a PDU session is rejected. Furthermore, the PDU session establishment reject message may be transmitted and/or received with the N1 interface included in the MM message. Furthermore, the NAS message may be a NAS message or a downlink NAS transport (DL NAS TRANSPORT) message. In this regard, the expression “the PDU session establishment reject message includes identification information and/or a value” may mean that the identification information and/or value is included in the MM message including the PDU session establishment reject message.

Here, by transmitting the PDU session establishment reject message, the SMF may indicate that the request from the UE represented by the PDU session establishment request is rejected. Furthermore, the SMF may include information indicating the cause of the rejection, in the PDU session establishment reject message for transmission, or may transmit the cause of the rejection to indicate the cause of the rejection. Moreover, in response to receiving the information indicating the cause of the rejection of the request from the UE, the UE may recognize the cause of the rejection of the request from the UE. Note that the cause of the rejection may be information indicating that the contents indicated by the identification information received by the SMF have not been allowed.

The SMF and/or AMF may include, in the PDU session establishment reject message, at least the 41st identification information and/or a backoff timer value and transmit the PDU session establishment reject message, or may indicate, by transmitting the 41st identification information and/or the backoff timer value, that the UE request has been rejected, or may indicate the cause of rejection of the UE request.

Furthermore, by transmitting the 41st identification information, the SNIT and/or the AMF may indicate that the request to establish a PDU session for the LADN is rejected or may indicate that no PDU session for the LADN is to be established. Furthermore, the SMF and/or AMF may indicate that the UE is located outside the LADN service, or may indicate that no PDU session for the LADN can be established in the current area. Furthermore, the SMF and/or AMF may indicate, by transmitting the 41st identification information, that the LADN information held by the UE is not valid, or may indicate that the LADN information held by the UE needs to be updated. In this regard, the LADN service area may be associated with the LADN DNN requested by the UE.

Furthermore, by transmitting the backoff timer, the SMF and/or AMF may indicate to the UE to configure the backoff timer value transmitted, or may indicate that a backoff timer configured with the value transmitted is to be started.

Furthermore, the SMF and/or MAE need not include the backoff timer value in the PDU session establishment reject message in a case that the 41st identification information is information indicating that the UE is located outside the LADN service area. In other words, the SMF and/or AMF may include the backoff timer value in the PDU session establishment reject message in a case that the 41st identification information is information other than the information indicating that the UE is located outside the LADN service area.

In this regard, in a case of transmitting the 41st identification information, the network apparatus may indicate to the UE to delete the LADN information stored by the UE, or may indicate to the UE to delete the LADN DNN requested by the UE from the LADN information stored by the UE. Furthermore, in a case of transmitting the 41st identification information, the network apparatus may indicate to the UE that the LADN DNN requested by the UE is invalid, or may indicate to the UE to invalidate the requested LADN DNN.

Furthermore, in a case of transmitting the 41st identification information, the network apparatus may indicate to the UE to recognize that the LADN DNN provided in the PDU session establishment procedure is invalid, or may indicate to the UE to invalidate LADN DNN provided in the PDU session establishment procedure.

Furthermore, in a case of transmitting the 41st identification information, the network apparatus may perform the registration procedure after the completion of the present procedure, or may initiate a Generic UE configuration update procedure. Note that the registration procedure may be the registration procedure for mobility and registration update. Furthermore, the registration procedure may be a procedure for providing new LADN information to the UE. Furthermore, the Generic UE configuration update procedure may be a procedure initiated by the AMF by transmitting a Configuration update command message to the UE, and may be a procedure for providing new LADN information to the UE.

In other words, in a case that a 5GSM cause value transmitted is a cause value indicating that the UE is located outside the LADN service, the network apparatus may indicate to the UE to delete the LADN information stored by the UE or may indicate to the UE to delete the LADN DNN requested by the UE from the LADN information stored by the UE. Furthermore, in a case that the 5GSM cause value transmitted is a cause value indicating that the network apparatus is located outside the LADN service, the network apparatus may indicate to the UE that the LADN DNN requested by the network apparatus is invalid or may indicate to the UE to invalidate the LADN DNN requested by the UE.

Furthermore, in a case that the 5GSM cause value is a cause value indicating that the UE is located outside the LADN service, the network apparatus may indicate to the UE to recognize that the LADN DNN provided in the PDU session establishment procedure is invalid or may indicate to the UE to invalidate the LADU DNN provided in the PDU session establishment procedure.

Furthermore, in a case that the 5GSM cause value transmitted is a cause value indicating that the UE is located outside the LADN service, the network apparatus may perform the registration procedure after the completion of the present procedure, or may initiate the Generic UE configuration update procedure. Note that the registration procedure may be the registration procedure for mobility and registration update. Furthermore, the registration procedure may be the procedure for providing new LADN information to the UE. Furthermore, the Generic UE configuration update procedure may be the procedure initiated by the AMF by transmitting the Configuration update command message to the UE, and may be the procedure for providing new LADN information to the UE.

Note that the SMF and the AMF may select and determine whether to include at least the 41st identification information in the PDU session establishment reject message based on each piece of identification information received, and/or the subscriber information, and/or the capability information of the network, and/or the operator policy, and/or the state of the network, and/or the registration information of the user, and/or the context held by the AMF, and/or the like. Specifically, the SMF and/or AMF may include the 41st identification information in the PDU session establishment reject message in a case that the UE is located outside the LADN service area. Note that the LADN service area may be an LADN service area associated with the LADN DNN requested by the UE.

By receiving the PDU session establishment reject message, the UE can recognize that the request from the UE represented by the PDU session establishment request is rejected, and details of various pieces of identification information included in the PDU session establishment reject message.

Each apparatus completes the PDU session establishment procedure, based on completion of the procedure of (A) or (B) of FIG. 7. Note that each apparatus may transition to a state in which a PDU session is established, based on completion of the procedure of (A) of FIG. 7, or may recognize that the PDU session establishment procedure is rejected or may transition to a state in which a PDU session is not established, based on completion of the procedure of (B) of FIC, 7. In addition, after completing the procedure of (A) of FIG. 7, the UE can communicate with the DN using the established PDU session.

In addition, each apparatus may perform processing based on information transmitted and/or received in the PDU session establishment procedure, based on completion of the PDU session establishment procedure. For example, in a case that each apparatus transmits and/or receives information indicating that a part of the request from the UE is rejected, each apparatus may recognize a reason of rejection of the request from the UE. In addition, each apparatus may perform the present procedure again or may perform the PDU session establishment procedure with respect to another cell, based on the reason of rejection of the request from the UE.

In addition, based on completion of the PDU session establishment procedure, the UE may store identification information received together with the PDU session establishment accept message and/or the PDU session establishment reject message, or may recognize determination of the network.

For example, in a case of transmitting and/or receiving the 36th identification information, each apparatus may establish a PDU session associated with the DNN indicated by the 36th identification information. Furthermore, in a case of receiving the 36th identification information, the UE may recognize that a PDU session associated with the DNN indicated by the 36th identification information is to be established. Furthermore, in a case of receiving the 36th identification information, the UE may recognize the DNN selected and determined by the network. Note that the 36th identification information may be a DNN that identifies a DN that supports one or multiple functions indicated by the identification information transmitted and/or received together with the 36th identification information. Furthermore, the 36th identification information may be a DNN received in the registration procedure, or may be the LADN.

Furthermore, in a case of receiving the backoff timer value, the UE may configure the backoff timer value for the backoff timer, or may start the backoff tinier configured with the backoff timer value received. In this regard, even in a case of receiving the backoff timer value, the UE may ignore the backoff timer value received or need not start the backoff timer in a case that the UE receives the 41st identification information. In contrast, even in a case of receiving the backoff timer value and the 41st identification information, the UE may configure the backoff timer value received for the backoff timer or may start the backoff timer configured with the backoff timer value received.

Specifically, in a case of receiving the 41st identification information indicating that the UE is located outside the LADN service area, the UE may ignore the backoff timer value received and need not start the backoff timer. In contrast, in a case of receiving the 41st identification information indicating that the UE is located outside the LADN service area, the UE may configure the backoff timer value received for the backoff timer, or may start the backoff timer configured with the backoff timer value received.

Furthermore, in a case that the UE, receives the 41st identification information, after the completion of the present procedure, the UE may initiate the PDU session establishment procedure under any other conditions based on the completion of the present procedure and/or the reception of the 41st identification information. Note that in a case that the UE is running the back timer, after the expiry of the backoff timer counting, the UE may initiate the PDU session establishment procedure under any other conditions

In this regard, the UE initiating the PDU session establishment procedure under any other conditions may mean, for example, the UE configuring, in the DNN information element, an LADN DNN that is different from the previously transmitted LADN DNN and transmitting the DNN information element to the network to initiate the PDU session establishment procedure, or changing the area where the UE is located and then transmitting the PDU session establishment request message to initiate the PDU session establishment procedure, or reflecting a change corresponding to a combination of the operations described above to initiate the PDU session establishment procedure. Note that the UE may configure, in the DNN information element, an LADN DNN reselected from the LADN information stored by the UE.

Alternatively, the t that the UE initiating the PDU session establishment procedure under any other conditions may mean the UE initiating the PDU session establishment procedure without using any LADN DNN. Specifically, the UE may request a PDU session for other than 5GLAN by performing transmission without LADN DNN in the PDU session establishment request message.

In a case that the UE receives the 41st identification information, the completion of the present procedure may lead to a transition to a state where the PDU session establishment procedure using the LADN DNN requested by the UE is not initiated, or a state where the PDU session establishment procedure is stopped, or a state where the PDU session establishment procedure is prohibited. In this regard, the PDU session establishment procedure using the LADN DNN requested by the UE may be a PDU session establishment procedure initiated by the UE by transmitting a PDU session establishment request message including a previously requested LADN DNN. In other words, in a case of receiving the 41st identification information, the UE may be prohibited from performing the PDU session establishment procedure using the same LADN DNN, or may be prohibited from transmitting the PDU session establishment request message including the same LADN DNN.

In a case that the UE receives the 41st identification information, after the completion of the present procedure, the UE may be prohibited from transmitting the PDU session establishment request message including the same LADN DNN in the same PLMN until the state of the UE changes. In this regard, a change in the state of the UE may be power-off of the UE or removal of a USIM. Furthermore, a change in the state of the UE may update of the information held by the UE. In this regard, the information held by the UE may be the LADN information. Furthermore, the update of the information held by the UE may be performed by the registration procedure, or by the Generic UE configuration update procedure. In other words, in a case that the UE receives the 41st identification information, after the completion of the present procedure, the UE may be prohibited from performing the PDU session establishment procedure for the same LADN DNN in the same PLMN or may be prohibited from transmitting the PDU session establishment request message for initiating the PDU session establishment procedure, until the registration procedure or the Generic UE configuration update procedure is performed. Furthermore, in other words, in a case that the UE receives the 41st identification information, after the completion of the present procedure, the UE may be prohibited from transmitting the PDU session establishment request message including the same LADN DNN in the same PLMN until the registration procedure or the Generic UE configuration update procedure is performed.

In a case that the UE receives the 41st identification information, the completion of the present procedure may lead to a transition to a state where the UE is prohibited from transmitting the PDU session establishment request message including the same LADN DNN for a certain duration, or a state where the UE is prohibited from transmitting the PDU session establishment request message including the same LADN DNN in the same PLMN, or a state where the UE is prohibited from transmitting the PDU session establishment request message including the same LADN DNN in the same area. In this regard, the certain duration may be a duration configured using the backoff timer value, or any other duration configured by the network or the UE.

In a case of receiving the 41st identification information, the UE may delete the stored LADN information, or may delete the LADN DNN requested by the UE from the stored LADN information. Furthermore, in a case of receiving the 41st identification information, the UE may recognize that the LADN DNN requested by the UE is invalid, or may invalidate the UE requested LADN DNN.

In other words, in a case of receiving the 41st identification information, the UE may recognize that the LADN DNN provided in the PDU session establishment procedure is invalid, or may invalidate the LADN DNN provided in the PDU session establishment procedure.

Furthermore, in a case of receiving the 41st identification information, the UE may initiate the registration procedure. Note that the registration procedure may be the registration procedure for mobility and registration update. Furthermore, the registration procedure may be a procedure for requesting new LADN information. Furthermore, in the registration procedure, in a case of receiving the LADN information, the UE may store the LADN information received.

In other words, in a case of receiving the 41st identification information, the UE may request the LADN information. In this regard, the LADN information may be the LADN information for the LADN DNN provided in the PDU session establishment procedure.

In other words, in a case that a 5GSM cause value received is a cause value indicating that the UE is located outside the LADN service, the UE may delete the stored LADN information or may indicate to the UE to delete the LADN DNN requested by the UE from the stored LADN information. Furthermore, in a case that the 5GSM cause value received is a cause value indicating that the UE is located outside the LADN service, the UE may recognize that the LADN DNN requested by the UE is invalid, or may invalidate the LADN DNN requested by the UE.

In other words, in a case that the 5GSM cause value received is a cause value indicating that the UE is located outside the LADN service, the UE may recognize that the LADN DNN provided in the PDU session establishment procedure is invalid, or may invalidate the LADN DNN provided in the PDU session establishment procedure.

Note that the expression “the LADN DNN is deleted” may mean that the information indicating the LADN configured by the LADN DNN is deleted, or that the LADN information including the LADN DNN is deleted. Furthermore, the expression “the LADN DNN is recognized as invalid” may mean that the information indicating the LADN configured by the LADN DNN is recognized as invalid, or the LADN information including the LADN DNN is recognized as invalid. Furthermore, the expression “the LADN DNN is invalidated” may mean that the information indicating the LADN configured by the LADN DNN is invalidated or that the LADN information including the LADN DNN is invalidated.

Furthermore, the UE may initiate the registration procedure in a case that the 5GSM cause value received is a cause value indicating that the UE is located outside the LADN service. More specifically, in a case that the 5GSM cause value received is a cause value indicating that the UE is located outside the LADN service, the UE may initiate the registration procedure based on a request from the upper layer and/or an indication from the user.

Note that the registration procedure may be the registration procedure for mobility and registration update. Furthermore, the registration procedure may be a procedure for requesting new LADN information. Furthermore, in the registration procedure, in a case of receiving the LADN information, the UE may store the LADN information received. Note that in the registration procedure, by transmitting the registration request message including the 2nd identification information, the UE may request new LADN information, or may acquire LADN information from the network. In the registration procedure, even in a case of transmitting a registration request message not including the 2nd identification information, the UE may acquire LADN information from the network.

In this regard, the UE may initiate the registration procedure to synchronize the network and the LADN information. Furthermore, the UE may initiate the registration procedure to avoid a failure due to the outside of the LADN service area.

In other words, the UE may request the LADN information in a case that the 5GSM cause value received is a cause value indicating that the UE is located outside the LADN service. In this regard, the LADN information may be the LADN information for the LADN DNN provided in the PDU session establishment procedure.

### 4. First Embodiment

Next, the first embodiment will be described. The first embodiment is hereinafter referred to as the present embodiment. In a communication procedure of the present embodiment, first, the UE performs network selection. Then, each apparatus performs the registration procedure initiated by the UE. Then, each apparatus performs the PDU session establishment procedure initiated by the UE to establish a PDU session, and transitions to a state in which the UE can perform communication with the DN by using the PDU session. Then, each apparatus transmits and/or receives user data by using the PDU session. Through the above processing, the procedure of the present embodiment completes.

Note that in the procedure of the present embodiment, the UE may select the PLMN or the SNPN in the network selection. More specifically, the UE may select the PLMN or SNPN based on the UE configuration information, and/or the information received from the network, and/or the mode of the UE. Specifically, in a case of operating in the SNPN access mode, the UE may perform SNPN selection instead of PLMN selection in the network selection. In contrast, in a case of not operating in the SNPN access mode, the UE may perform the PLMN selection in the network selection.

In a case of selecting the SNPN in the network selection, the UE may transition to a state in which the SNPN access mode is active. In contrast, in a case of selecting the PLMN in the network selection, the UE may transition to a state in which the SNPN access mode is inactive.

Furthermore, in the registration procedure, each apparatus may exchange support information for the extension of the LADN service area and/or the LADN information between the UE and the network.

Furthermore, in the PDU session establishment procedure, each apparatus may establish a PDU session for the LADN between the UE and the network based on the information exchanged in the registration procedure. Note that the PDU session for the LADN may be a PDU session that can be established only in a case that the UE is located in a specific area. In this regard, the specific area may be, for example, the LADN service area.

Furthermore, each apparatus may perform user data communication with the LADN by using the established PDU session. Furthermore, based on the update of the LADN information and/or a change in the state of the LADN service area, each apparatus may release the established PDU session or release the user plane resources associated with the established PDU session.

Furthermore, in a case that the request for the PDU session establishment procedure is rejected, each apparatus need not establish a PDU session. In this case, after the completion of the PDU session establishment procedure, each apparatus may perform processing based on information included in the PDU session establishment reject message or may complete the procedure of the present embodiment by performing the processing based on the information included in the PDU session establishment reject message.

### 5. Second Embodiment

Next, a second embodiment will be described. The second embodiment is hereinafter referred to as the present embodiment. In a communication procedure of the present embodiment, first, the UE performs network selection. Then, each apparatus performs the registration procedure initiated by the UE. Then, each apparatus performs the PDU session establishment procedure initiated by the UE to establish a PDU session, and transitions to a state in which the UE can perform communication with the DN by using the PDU session. Then, each apparatus transmits and/or receives user data by using the PDU session. Through the above processing, the procedure of the present embodiment completes.

Note that in the procedure of the present embodiment, the UE may select the PLMN or the SNPN in the network selection. More specifically, in a case of operating in the SNPN access mode, the UE may perform the SNPN selection instead of the PLMN selection in the network selection. In contrast, in a case of not operating in the SNPN access mode, the UE may perform the PLMN selection in the network selection. In a case of selecting the SNPN in the network selection, the UE may transition to the state in which the SNPN access mode is active. In contrast, in a case of selecting the PLAN in the network selection, the UE may transition to the state in which the SNPN access mode is inactive. Furthermore, based on the success of the SNPN selection, the UE may recognize that the LADN is not adapted in the selected SNPN. In other words, based on the success of the SNPN selection, the UE may recognize that no access to the LADN is supported. In other words, based on the success of the SNPN selection, the UE may recognize that the access to the LADN is prohibited.

Furthermore, in the registration procedure, each apparatus may exchange the support information for the extension of the LADN service area and/or the LADN information between the UE and the network. Note that in a case that the UE is operating in the SNPN access mode, then in the registration procedure, each apparatus may be prohibited from exchanging the support information for the extension of the LADN service area anchor the LADN information between the UE and the network. In other words, in a case that the UE is operating in the SNPN access mode, then in the registration procedure, the UE may be prohibited from including the 2nd identification information in the registration request message or from transmitting the registration request message including the 2nd identification information. Furthermore, in a case that the UE is operating in the SNPN access mode, then in the registration procedure, the network may reject the request from the UE for the LADN information.

Furthermore, in the PDU session establishment procedure, each apparatus may establish a PDU session for the LADN between the UE and the network based on the information exchanged in the registration procedure. Note that the PDU session for the LADN may be a PDU session that can be established only in a case that the UE is located in a specific area. In this regard, the specific area may be, for example, the LADN service area. Note that, in a case that the UE is operating in the SNPN access mode, then in the PDU session establishment procedure, each apparatus may be prohibited from establishing a PDU session for the LADN between the UE and the network. In other words, in a case that the UE is operating in the SNPN access mode, then in the PDU session establishment procedure, the UE may be prohibited from including the LADN DNN in the PDU session establishment request message or from transmitting the PDU session establishment request message including the LADN DNN. Furthermore, in a case that the UE is operating in SNPN access mode, then in the PDU session establishment procedure, the network may reject the request to establish a PDU session for LADN. In this case, the network may transmit, to the UE, the PDU session establishment reject message including the 41st identification information.

Furthermore, in a case that the request for the PDU session establishment procedure is rejected, each apparatus need not establish a PDU session. In this case, after the completion of the PDU session establishment procedure, each apparatus may perform the processing based on the information included in the PDU session establishment reject message or may complete the procedure of the present embodiment by performing the processing based on the information included in the PDU session establishment reject message.

### 6. Modified Examples

A program running on an apparatus according to the present invention may serve as a program that controls a Central Processing Unit (CPU) and the like to cause a computer to operate in such a manner as to realize the functions of the aforementioned embodiment according to the present invention. Programs or information handled by the programs are temporarily stored in a volatile memory such as a Random Access Memory (RAM), a non-volatile memory such as a flash memory, a Hard Disk Drive (HDD), or another storage device system.

Note that a program for realizing the functions of the embodiments according to the present invention may be recorded on a computer-readable recording medium. The functions may be realized by causing a computer system to load the program recorded on the recording medium for execution. It is assumed that the “computer system” refers to a computer system built into the apparatuses, and the computer system includes an operating system and hardware components such as a peripheral device. Furthermore, the “computer-readable recording medium” may be any of a semiconductor recording medium, an optical recording medium, a magnetic recording medium, a medium dynamically retaining the program for a short time, or any other computer readable recording medium.

Furthermore, each functional block or various features of the apparatuses used in the aforementioned embodiment may be implemented or performed on an electric circuit, for example, an integrated circuit or multiple integrated circuits, An electric circuit designed to perform the functions described in the present specification may include a general purpose processor, a digital signal processor (DSP), an application specific integrated circuit (ASIC), a field programmable gate array (FPGA), or other programmable logic devices, discrete gates or transistor logic, discrete hardware components, or a combination thereof. The general-purpose processor may be a microprocessor, or may be a processor of a known type, a controller, a micro-controller, or a state machine instead. The aforementioned electric circuit may include a digital circuit or may include an analog circuit. In a case that with advances in semiconductor technology, a circuit integration technology appears that replaces the present integrated circuits, one or multiple aspects of the present invention are also possible to use a new integrated circuit based on the technology.

Note that the invention of the present application is not limited to the above-described embodiments. In the embodiment, apparatuses have been described as an example, but, the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

Although, the embodiments of the present invention have been described in detail above referring to the drawings, the specific configuration is not limited to the embodiments and includes, for example, design changes within the scope not depart from the gist of the present invention. Furthermore, in the present invention, various modifications are possible within the scope of claims, and embodiments that are made by suitably combining technical means disclosed according to the different embodiments are also included in the technical scope of the present invention. Furthermore, a configuration in which elements described in the respective embodiments and having mutually the same effects, are substituted for one another is also included.

### REFERENCE SIGNS LIST

1 Mobile communication system

5 PDN_A

6 DN_A

10 UE_A

30 PGW-U

32 PGW-C

35 SGW

40 MME

45 eNB

50 HSS

60 PCRF

80 Access network_A (E-UTRAN)

90 Core network_A

120 Access network_B (5G AN)

122 gNB

130 UPF

132 SMF

140 AMF

150 UDM

160 PCF

190 Core network_B

1-6. (canceled)

7. A User Equipment (UE) comprising:
transmission and/or reception circuitry configured to receive a REGISTRATION ACCEPT message with Local Area Data Network (LADN) information from a control device; and
a controller configured to store the LADN information in a case of receiving the REGISTRATION ACCEPT message,
wherein
the LADN information includes LADN service area information,
in a case that the UE is operating in SNPN access mode, the controller considers the LADN information to be valid in Tracking Area Identities (TAIs) of a registered Stand-alone Non-Public Network (SNPN), and
the TAIs of the registered SNPN are in the LADN service area information.

8. The UE according to claim 7, wherein
in a case that the UE is not operating in SNPN access mode, the controller considers the LADN information to be valid in TAIs of a registered Public Land Mobile Network (PLMN), and
the TAIs of the registered PLMN are in the LADN service area information.

9. The UE according to claim 8, wherein
in a case that the UE is not operating in SNPN access mode, and the LADN service area information includes TAIs for the equivalent PLMNs, the controller considers the LADN information to be valid in TAIs of equivalent PLMNs.

10. A communication control method performed by a User Equipment (UE), the communication control method comprising:
receiving a REGISTRATION ACCEPT message with Local Area Data Network (LADN) information from a control device; and
storing the LADN information in a case of receiving the REGISTRATION ACCEPT message, wherein
the LADN information includes LADN service area information,
in a case that the UE is operating in SNPN access mode, the UE considers the LADN information to be valid in Tracking Area Identities (TAIs) of a registered Stand-alone Non-Public Network (SNPN), and
the TAIs of the registered SNPN are in the LADN service area information.
